(19) United States
(12) Patent Application Publication
(10) Pub. No.: US 2016/0266235 A1
(43) Pub. Date: Sep. 15, 2016

(54) DRIVER SIDE LOCATION DETECTION

(71) Applicants: Marwan HANNON, San Francisco, CA (US); Peter Qiang QU, New Market, MD (US); DRIVING MANAGEMENT SYSTEMS, INC., San Francisco, CA (US)

(72) Inventors: Marwan Hannon, San Francisco, CA (US); Peter Qiang Qu, New Market, MD (US)

(21) Appl. No.: 15/035,210

(22) PCT Filed: Nov. 7, 2014
(86) PCT No.: PCT/US2014/064627

§ 371 Date: May 6, 2016

Related U.S. Application Data
(60) Provisional application No. 61/901,241, filed on Nov. 7, 2013.

(51) Int. Cl. G01S 5/30; H04M 1/725

(52) U.S. Cl. CPC G01S 5/30; H04M 1/72572

(57) ABSTRACT

A system for determining a presence of a mobile device located in a predetermined detection zone includes a circuit associated with the mobile device and configured to cause an acoustic signal to be transmitted from the mobile device, a plurality of acoustic receivers, where each of the plurality of receivers is configured to receive the acoustic signal transmitted from the mobile device and convert the acoustic signal into an electrical signal, and a processor configured to determine a location of the mobile device based on the time of reception of the acoustic signal by the plurality of acoustic receivers and to determine whether the location of the mobile device matches the predetermined detection zone.

### CROSS REFERENCE TO RELATED APPLICATION

This application claims the benefit, under 35 USC §119(e), of U.S. provisional patent application No. 61/901,241, filed Nov. 7, 2013, entitled “DRIVER SIDE LOCATION DETECTION”, the entire disclosure of which is hereby incorporated by reference.

### BACKGROUND

Mobile devices such as wireless devices, including, for example, cellular telephones, smart phones, laptop computers, notebook computers, tablet devices (e.g., iPad by Apple®) are ubiquitous in modern society. Use of such mobile devices while operating a vehicle, however, can be hazardous. The problem is exacerbated for inexperienced operators of the vehicle, such as youngsters just learning how to drive. Rates of vehicular accidents where mobile devices are involved are rising, especially with teenagers. Text messaging while operating a moving vehicle can be dangerous and has been linked with causing accidents. More generally, operating any keyboard while operating a vehicle can be dangerous.

Thus, the widespread adoption of mobile devices and common use of the devices while driving has raised concerns about the distraction of drivers. A driver speaking or text messaging on a mobile telephone may become mentally distracted from driving and lose control of the vehicle that he or she is driving. Thus, it is not uncommon to see an individual involved in an accident who was speaking or text messaging on a mobile device rather than paying attention to the road. Studies now suggest that individuals speaking on mobile telephones while driving a car may be as impaired as a person who drives while intoxicated. Not only is the driver mentally distracted, but eyes of the driver are diverted for dialing, looking to see who an incoming call is from.

It would be highly desirable to detect the presence of a mobile device, such as a wireless device, within a vehicle and control or inhibit the operation of the mobile device.

### SUMMARY

With the advancement of mobile technology, we have the capability to stay connected at all time. For many people, the urge to stay connected does not stop when they are behind the driving wheel. Driving while distracted by mobile technology is an endangerment to both the driver and general public. The present disclosure seeks to discourage distracted driving by partially inhibiting a function of a mobile device that might otherwise be used in a moving vehicle and in the proximity of the driver seat. This document provides details regarding technology that detects whether the mobile device is on the driver seat.

Most location detection technology relies on two phenomena of physics: time of arrival and received power. The time of arrival (TOA) is a location detection technique. If a distant transmitter emits a wave, and the receiver detects the wave at a later time, the distance between the transmitter and receiver is determined by the formula d=V*t, where V is the propagation velocity of the wave, and t is the time that the wave takes to arrive at the receiver. TOA detection has been used extensively with sound wave (such as sonar), because of the relative slow speed of sound lends to high location detection accuracy. At normal temperature, pressure and humidity, sound wave travels at 340 meters per second, or approximately 1 foot per millisecond. Many animals and modern instruments are capable of measuring TOA with sufficient accuracy for good location detection. For example, some dolphins and bats are known to use ultrasonic echo to locate their prey. Additionally, submarines use sonar to detect enemy vessels. Further, backup sensors installed on vehicles use ultrasonic sonar to detect obstruction.

The use of TOA with electromagnetic wave has been limited due to high speed of the electromagnetic wave. All electromagnetic waves travel at speed of light, that is 3*10̂8 m/s, or approximately 1 foot per nanosecond. If sub-meter location accuracy is desired, then synchronization between transmitter and receiver, and the measurement of TOA must have accuracy of sub-nanoseconds. The electronic systems capable of measuring nanoseconds, or at high GHz frequency, are often expensive. An interesting implementation of TOA with electromagnetic wave is the Global Positioning System. The GPS partially circumvents the nanoseconds timing challenge by having multiples GPS satellites synchronized using atomic clocks, and then continuously send GPS signal packets containing the time stamp from the satellites. The GPS receivers at the ground now are relieved from the burden of high accuracy synchronization, but still have to measure relative delays between multiple GPS signals accurately. It is only within the recent decade that the cost of GPS receiver came down dramatically, making GPS affordable to more consumers.

The power or signal strength of a wave weakens as the receiver moves further away from the transmitter. If the distance between the transmitter and receiver is R, then the power density sensed by the receiver is given by the equation below (Wolff):

$${S}_{u} = \frac{{P}_{s}}{4 \cdot π \cdot {R}^{2}}$$

Where Sᵤ is the received power density and Pₛ is the power from the transmitter.

Many modern technologies make use of this phenomenon to perform distance detection. Radar is one of the most well known examples where a radar transmitter sends an electromagnetic wave, and measured the received power of the electromagnetic waves reflects off an object from the distance. In consumer electronic technology, various location detection techniques have been developed using Received Signal Strength (RSS) measurements of wireless signals such as cellular, Wifi and Bluetooth. For example, the Wifi Positioning Technology promoted by Google, Skyhook and Navizon uses measured RSS to known Wifi access points to determine the location of mobile devices (Skyhook).

The received power approach to location detection may have limiting factors, which can include:

1) Signal noise: noise from various sources such as electronic (thermal, shot, flicker) can degrade the accuracy of the measured RSS;

2) Interference: reflection and refraction of the wave can lead to less accurate measurement. In addition, if more than one transmitter shares the same frequency spectrum, then the crowding effect further degrades RSS measurement; and

3) Obstruction: if there is any obstruction between the transmitter and receiver, then the received power is no longer solely dependent on the distance, but also the extent of the obstruction.

In one embodiment, a system, comprising hardware and software, uses the TOA of high frequency sound waves (such as, for example, 19 KHz) for driver set location detection. In one embodiment, the present disclosure comprises software that functions as an application that can be installed on mobile devices, such as a smartphone, tablet, and etc. hardware is installed on the vehicle and consists of at microphones, speakers and an embedded processor. The present disclosure provides two methods of mobile device detection. In one embodiment, an active detection method, multiple microphones are placed inside the vehicle and are utilized to detect a high frequency sound signal emit by a mobile device. In another embodiment, a passive detection method, an audio signal emitted by multiple speakers installed in a car is detected by a mobile device.

### DESCRIPTION OF THE FIGURES

The novel features of the various embodiments are set forth with particularity in the appended claims. The various embodiments, however, both as to organization and methods of operation, together with the advantages thereof, may be understood by reference to the following description taken in conjunction with the accompanying drawings as follows.

FIG. 1 is a flowchart of a method of determining a presence of a mobile device located in a predetermined detection zone according to an embodiment of the present disclosure.

FIG. 2 is a flowchart of a method of determining a presence of a mobile device located in a predetermined detection zone according to another embodiment of the present disclosure.

FIG. 3 is a diagram of a system for determining a presence of a mobile device located in a predetermined detection zone according to an embodiment of the present disclosure.

FIG. 4 is an illustration of an array of microphones installed inside of a vehicle.

FIG. 5 is a display of a screen capture of a version of an interface for a mobile application according to an embodiment of the present disclosure.

FIG. 6 is a flowchart of a method of processing an acoustic signal according to one embodiment of the present disclosure.

FIG. 7 is an illustration of an acoustic signal that comprises three pulses at 19 kHz.

FIG. 8 is a close up illustration of a single 19 KHz pulse shown in FIG. 7.

FIG. 9 is an illustration of a Fourier transform of an acoustic signal having a single peak at 19 KHz.

FIG. 10 is an illustration of an input sound recording that comprises two pulses.

FIG. 11 is an illustration of extracted volume data of the two pulses shown in FIG. 10.

FIG. 12 is a flowchart of a method for identifying a starting time of sound pulse according to an embodiment of the present disclosure.

FIG. 13 is a display of a Sallen-Key filter.

FIG. 14 is a display of a State Variable filter.

FIG. 15 is a display of a Biquadratic (Biquad) filter.

FIG. 16 is a display of a Multiple Feedback Bandpass filter.

FIG. 17 is a display of a Dual Amplifiers Band-Pass (DAPB) filter.

FIG. 18 is a diagram of a system for determining a presence of a mobile device located in a predetermined detection zone according to an embodiment of the present disclosure.

FIG. 19 is an illustration of a plurality of speakers installed inside of a vehicle.

FIG. 20 is an illustration of a calculation process for determining a relative location of a mobile device according to an embodiment of the present disclosure.

FIG. 21 is an illustration of components of a custom electronic hardware device according to an embodiment of the present disclosure.

FIG. 22 is a screen capture of the board design of the hardware device shown in FIG. 21 in Ultiboard CAD software.

FIG. 23 is a 3D preview of a transducer board of the hardware device shown in FIG. 21.

FIG. 24 is a circuit board layout of a transducer board of the hardware device shown in FIG. 21.

FIG. 25 is a high-level illustration of the hardware device shown in FIG. 21.

FIG. 26 shows an implementation of a sound recorder according to an embodiment of the present disclosure using LabView FPGA design language.

FIG. 27 and 28 are illustrations of noise reduction behavior of a sound filter according to an embodiment of the present disclosure.

FIG. 29 is an illustration an implementation of a sound filter according to an embodiment of the present disclosure in a Xilinx LX45 FPGA.

FIG. 30 is a filter implementation in LabView FPGA of the sound filter of FIG. 29.

FIG. 31 is a magnitude Bode Plot of the FIR Band pass filter of FIG. 29.

FIG. 32 is the step response of the FIR Band pass filter of FIG. 29.

FIG. 33 is the step response of the IIR Filter of FIG. 29.

FIG. 34 is an illustration of an input sound recording that contains two pulses according to an embodiment of the present disclosure.

FIG. 35 is an illustration of extracted volume data of the two pulses shown in FIG. 34.

FIG. 36 is a LabView Implementation illustrating the background noise calculation according to an embodiment of the present disclosure.

FIG. 37 is an illustration of the volume data of the two pulses shown in FIG. 34 prior to noise removal.

FIG. 38 is an illustration of the volume data of the two pulses shown in FIG. 34 after noise removal.

FIG. 39 is an illustration of a LabView Implementation of noise removal according to an embodiment of the present disclosure.

FIG. 40 is an illustration of a LabView Implementation of a pulse detection algorithm according to an embodiment of the present disclosure.

FIG. 41 is an illustration of a LabView Implementation of pulses down selection according to an embodiment of the present disclosure.

FIG. 42 is an illustration of a LabView Implementation of a ping search algorithm according to an embodiment of the present disclosure.

FIG. 43 is an illustration of a setup of speakers and microphone used during a test of demonstration software according to an embodiment of the present disclosure.

FIG. 44 is a screenshot from the demonstration software.

FIG. 45 is an illustration of an ultrasonic transducers setup used by the demonstration software.

FIG. 46 is a time series plot of a raw sound recording used by the demonstration software.

FIG. 47 is a time series plot of the sound recording of FIG. 46 after a digital filter used by the demonstration software.

FIG. 48 is an illustration of an input sound recording that contains the two pings used by the demonstration software.

FIG. 49 is an illustration of extracted volume data of the two pings shown in FIG. 48.

FIG. 50 is an illustration of the volume data of the two pulses shown in FIG. 48 prior to noise removal.

FIG. 51 is an illustration of the volume data of the two pulses shown in FIG. 48 after noise removal.

### DETAILED DESCRIPTION

Various embodiments are described to provide an overall understanding of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting embodiments and that the scope of the various embodiments is defined solely by the claims. The features illustrated or described in connection with one embodiment may be combined, in whole or in part, with the features of other embodiments. Such modifications and variations are intended to be included within the scope of the claims.

The present disclosure describes embodiments of an apparatus, system, and method for detecting the presence of a mobile device, such as a wireless device, in a predetermined detection zone and controlling or inhibiting operation of the mobile device when it is detected in the predetermined detection zone. In particular, the present disclosure is directed to embodiments of an apparatus, system, and method for detecting the presence of a mobile device such as a wireless device in a predetermined detection zone within a vehicle and disabling some or all of the functions of the mobile device when it is detected in the predetermined detection zone. More particularly, the present disclosure is directed at automatically preventing a person in the driver's seat of a vehicle from text messaging and doing other similar excessively dangerous activities using a mobile device.

It is to be understood that this disclosure is not limited to particular aspects or embodiments described, as such may vary. It is also to be understood that the terminology used herein is for the purpose of describing particular aspects or embodiments only, and is not intended to be limiting, since the scope of the apparatus, system, and method for detecting the presence of a mobile device within a predetermined zone within a vehicle and controlling the operation of the mobile device when it is detected is defined only by the appended claims.

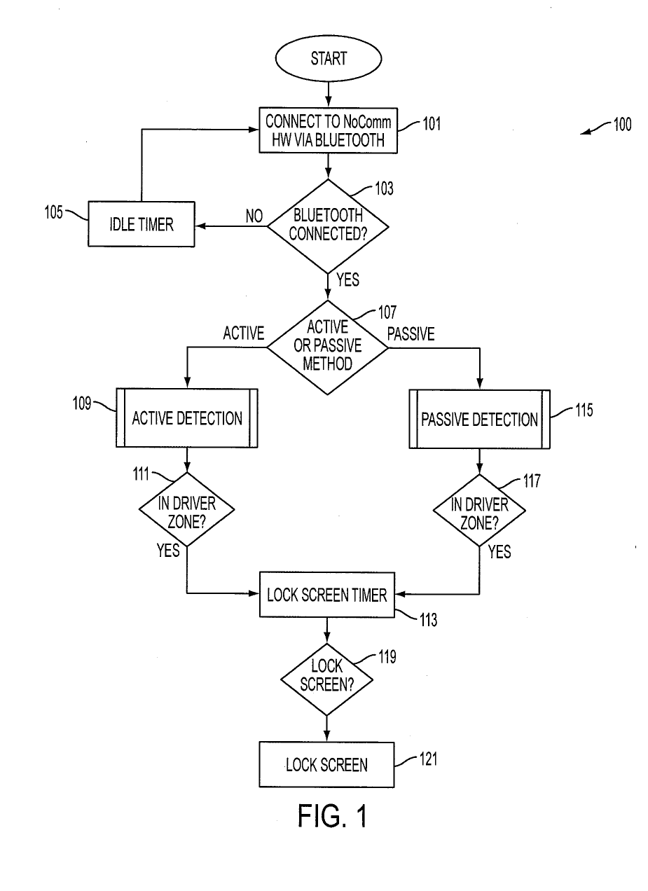

The present disclosure describes two theories of determining a presence of a mobile device located in a predetermined detection zone, which are referred to generally as active detection and passive detection. As shown in FIG. 1, a method 100 according to the present disclosure comprises connecting a mobile device to a hardware component 101, which is independent of the mobile device, via a wireless technology standard for exchanging data, for example via Bluetooth, determining whether the mobile device is coupled to the hardware component 103, and if the mobile device is determined not to be connected, activating an idle timer 105 to allow for the connection to be implemented. Further, the method comprises determining whether to implement an active or passive detection method 107, upon determining that an active detection method is implemented 109, determining whether the mobile device is located within a predetermined zone 111, such as a driver's area in the cabin of a vehicle, and upon determining that the mobile device is located within the predetermined zone, initiating a screen timer of the mobile device 113. Further, as shown in FIG. 1, upon determining that a passive detection method is implemented 115, the method 100 further comprises determining whether the mobile device is located within the predetermined zone 111, and upon determining that the mobile device is located within the predetermined zone, initiating a screen timer of the mobile device 113. Once a lock screen timer is activated, the method comprises determining whether to the lock the screen of the mobile 119 based on a received control or command signal such that at least one function of the mobile device is inhibited, and upon determining that an appropriate command or control signal was received, inhibiting the at least one function of the mobile device 121.

In various embodiments, a mobile device may be implemented as a handheld portable device, computer, mobile telephone, sometimes referred to as a smartphone, tablet personal computer (PC), laptop computer, or any combination thereof. Non-limiting examples of smartphones include, for example, Palm® products such as Palm® Treo® smartphones (now Hewlett Packard or HP), Blackberry® smart phones, Apple® iPhone®, Motorola Droid®, and the like. Tablet devices include the iPad® tablet computer by Apple® and more generally a class of lightweight portable computers known as Netbooks. In some embodiments, the mobile device may be comprise, or be implemented as, any type of wireless device, mobile station, or portable computing device with a self-contained power source (e.g., battery) such as a laptop computer, ultra-laptop computer, personal digital assistant (PDA) with communications capabilities, cellular telephone, combination cellular telephone/PDA, mobile unit, subscriber station, user terminal, portable computer, handheld computer, palmtop computer, wearable computer, media player, pager, messaging device, data communication device, and so forth.

Accordingly, systems and methods of detecting the presence of the mobile device may vary based on the wireless technology communication standards used by the mobile device. Examples of wireless technology communication standards that may be used In the United States, for example, may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), 4G systems, CDMA-2000, Universal Mobile Telephone System (UMTS) systems, Integrated Digital Enhanced Network (iDEN) (a TDMA/GSM variant) and so forth. A mobile device may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques. An example of EMI techniques may include passive or active radio-frequency identification (RFID) protocols and devices. These wireless communications standards are understood by one of ordinary skill in the art.

Once an appropriate command or control signal is detected, operation of the mobile device may be controlled in one or more ways. For example, in one embodiment, the mobile device is associated with a control module that disables or inhibits the operation of at least one function of the mobile device and the mobile device is rendered either inoperable or operable only in a state of limited capacity. Accordingly, the control module may be able to either completely block the ability to receive or send a call on a mobile device, or sufficiently interfere with a function of the mobile device so as to make the mobile device usage undesirable. In embodiments, the control module may disable the operation of certain components or functions of the mobile device. For example, a keyboard portion of a mobile device may be disabled to prevent the user from using a text messaging function or an email function of the mobile device. In another embodiment, the control module may direct the operation of the mobile device to a hands-free operation. In another embodiment, outgoing communication functions may be inhibited, but incoming communication functions may be uninhibited. In another embodiment, automatic replies may be initiated during a period in which a function of the mobile device is inhibited.

In embodiments, the control module may be independent of the mobile device and may communicate with the mobile device on a primary communication channel of the mobile device only or in addition to one or more secondary channels. Further, in certain embodiments, the control module may be activated only if other logical conditions are met such as the state of the ignition system, a state of a gear box, or other sensors. Accordingly, a triggering condition may be the activation of a switch, such as the ignition switch of a vehicle, or deactivation of a “park” sensor of an automatic transmission of the vehicle, among other sensors. In embodiments, the control module may allow emergency functions, such as 911 calls, when active.

In embodiments, a command or control signal may be localized to other areas within the vehicle so that operation of a mobile device in that area is disabled, but leaving other mobile devices outside of that area operational. In various embodiments, the power level of a command or control signal may be configured such that the command or control signal is delivered precisely to the predetermined detection zone. In one embodiment, this may be implemented with a directional antenna located within the vehicle where the signal is delivered to precisely the predetermined detection zone.

In embodiments described herein, a predetermined detection zone may be defined as a three-dimensional zone within or in proximity of a driver seat in a vehicle. A predetermined detection zone may be a zone within a vehicle, such as a passenger car; however, the predetermined detection zone need be within a vehicle and may be any predetermined zone as appropriate. For instance, the predetermined detection zone may be an area within a room in a building.

In one embodiment of a theory of the present disclosure, which may be referred to as active detection, a method for determining a presence of a mobile device located in a predetermined detection zone, comprises transmitting, by the mobile device, an acoustic signal, receiving, at each of a plurality of acoustic receivers, the acoustic signal transmitted from the mobile device, determining, by a processor, a location of the mobile device based on the received acoustic signal, determining whether the location of the mobile device matches the predetermined detection zone, and inhibiting at least one function of the mobile device upon determining that the location of the mobile device matches the predetermined detection zone. The method may further comprise monitoring a communication channel for a control or a command signal and inhibiting the at least one function of the mobile device upon reception of the control or command signal. According to one embodiment, the communication channel may be a Bluetooth channel or any other connection that is secondary to the primary cellular communication channel

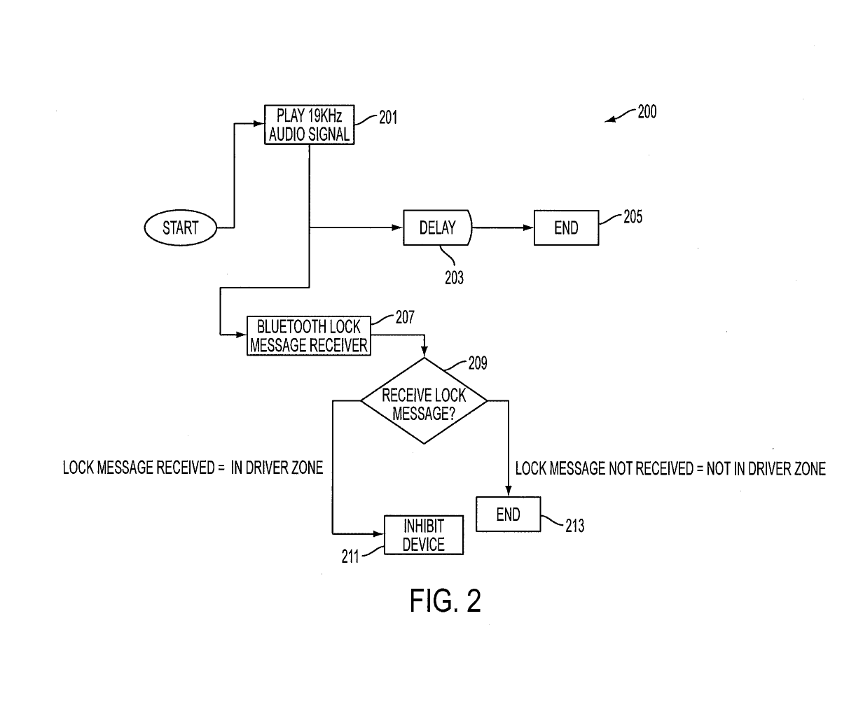

In another embodiment shown in FIG. 2, a method for determining a presence of a mobile device located in a predetermined detection zone comprises transmitting an acoustic signal 201, such as an audio signal focused in the 19 kHz bandwidth. A delay 203 may be implemented following the transmitting the acoustic signal for monitoring whether a lock message is received via a wireless communication channel of the mobile device, such as a Bluetooth connection. The lock message may be transmitted from a hardware device installed in a cabin of a vehicle. In the event that a lock message is not detected, the method 200 ends at 205. The method 200 further comprises, activating a Bluetooth lock message receiver 207 and determining if a lock message has been received via the Bluetooth connection of the mobile device 2 09. If the lock message is received, the method comprises inhibiting a function of the mobile device 2 11, such as by disabling a screen of the mobile device. Reception of the lock message indicates that the mobile device is in the predetermined detection zone, such as a driver seating area or other zone of the vehicle. If the lock message is not received, this indicates that the mobile device is not in the predetermined detection zone, and the method 200 ends at 213.

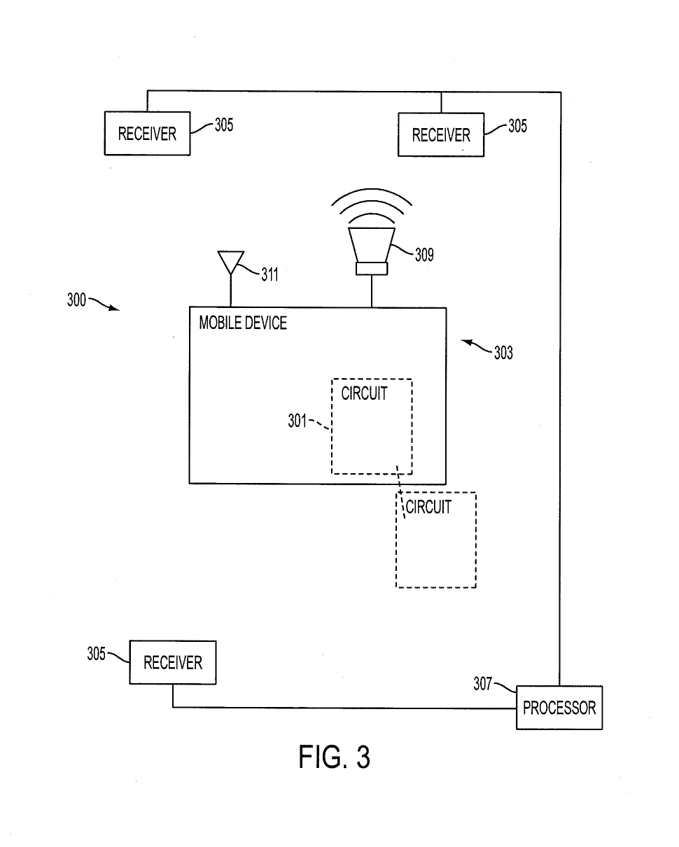

An embodiment of a system for determining a presence of a mobile device located in a predetermined detection zone is shown in FIG. 3. The system 300 comprises a circuit 301 associated with a mobile device 303, a plurality of acoustic receivers 305, and an electronic device 307, such as a processor, configured to determine a location of the mobile device 303.

The circuit 301 may be configured to cause an acoustic signal to be transmitted from the mobile device 303. In one embodiment, the acoustic signal may be output from a speaker 309 of the mobile device at high volume via a speaker 309 of the mobile device 303. Further, each of the plurality of receivers 305 may be configured to receive the acoustic signal transmitted from the mobile device 303 and convert the acoustic signal into an electrical signal. Additionally, the processor 307 may be configured to determine the location of the mobile device based on the time of reception of the acoustic signal by the plurality of acoustic receivers 305 and to determine whether the location of the mobile device 303 matches the predetermined detection zone. As shown in the embodiment of FIG. 3, the circuit 301 may be located within the mobile device 303 or it may be communicatively coupled to the mobile device 303 such that control and/or command signals can be exchanged between the circuit 301 and the mobile device 303.

Furthermore, in embodiments, the circuit 301 may comprise a control module associated with the mobile device 303, where the control module 301 is coupled to a non-transitory memory that stores executable instructions, wherein the control module 301 is operable to execute the instructions stored in the memory. The control module may be operable to execute the instructions to cause an acoustic signal to be transmitted from the mobile device 303 to a plurality of acoustic receivers 305, receive a command signal from a processor 307 configured to determine a location of the mobile device 303 based on the time of reception of the acoustic signal by the plurality of acoustic receivers 305 and determine whether the location of the mobile device 303 matches the predetermined detection zone, and inhibit at least one function of the mobile device 303 upon reception of the command signal. In one embodiment, the control module 301 may be located within the mobile device. In another embodiment, the circuit may be in communication with the mobile device through a communication network, such as a wireless communication network.

The control module 301 may be configured to inhibit the at least one function of the mobile device 303 upon the processor 307 determining that the location of the mobile device matches the predetermined detection zone. The control module 301 may also be configured to redirect at least one function of the mobile device 303 to a hands-free alternate system upon the processor 307 determining that the location of the mobile device 303 matches the predetermined detection zone.

In embodiments, the system 300 may use the Time of Arrival (TOA) of the acoustic signal for detection of the mobile device 303 and to determine whether the mobile device is in a driver side location of a vehicle. The acoustic signal may comprise at least one sonic pulse, which may be an ultrasonic pulse. In one embodiment, the at least one ultrasonic pulse is transmitted at a range of 15 KHz to 25 KHz. In another embodiment, the at least one ultrasonic pulse is transmitted at a range of 18 KHz to 20 KHz. In a further embodiment, the at least one ultrasonic pulse is transmitted at 19 KHz. Using a narrow-bandwidth 19 KHz acoustic pulse or beep may allow for aggressive digital filtering to attenuate background noise. Furthermore, a narrow-bandwidth 19 KHz acoustic pulse or beep may improve localization sensitivity over a range of frequencies since a wider bandwidth may contain more noise in a pass band directed to such a range of frequencies. Additionally, using a narrow-bandwidth 19 KHz acoustic pulse or beep may allow for transmission at a lower acoustic volume.

Once a determination is made by the processor 307 as to whether the mobile device 303 is within the predetermined detection zone, the processor 307 may cause a signal to be sent to the mobile device 303 for inhibiting a function of the mobile device 303. The signal may be received via an antenna 311 of the mobile device 303. The antenna 311 may be a component of the primary communication scheme of the mobile device 303 or a component of a secondary communication scheme of the mobile device, such as Bluetooth. Once an appropriate signal is received, operation of the mobile device may be controlled in one or more ways. For example, in one embodiment, the mobile device 303 is associated with control module 301 that disables or inhibits the operation of at least one function of the mobile device 303. Thus the mobile device 303 is rendered either inoperable or operable only in a state of limited capacity. Accordingly, the control module 301 may be able to either completely block the ability to receive or send a call on a mobile device 303, or sufficiently interfere with a function of the mobile device 303 so as to make the mobile device 303 usage undesirable. In embodiments, the control module 301 may disable the operation of certain components or functions of the mobile device. For example, a keyboard portion of a mobile device 301 may be disabled to prevent the user from using a text messaging function or an email function of the mobile device. In another embodiment, the control module 301 may direct the operation of the mobile device 303 to a hands-free operation. In another embodiment, outgoing communication functions may be inhibited, but incoming communication functions may be uninhibited. In another embodiment, automatic replies may be initiated during a period in which a function of the mobile device 303 is inhibited.

In embodiments, the processor 307 may be coupled to a non-transitory memory that stores executable instructions, and the processor 307 may be operable to execute the instructions. The processor 307 may be operable to execute the instructions to receive a plurality of a electrical signals from the plurality of acoustic receivers 305, where each electrical signal is based on an acoustic signal received by each of the plurality of acoustic receivers 305, to determine a location of the mobile device 303 based on the time of reception of the acoustic signal by the plurality of acoustic receivers 305, and to determine whether the location of the mobile device 303 matches the predetermined detection zone. In one embodiment, the processor 307 is operable to determine the location of the mobile device 303 based on a distance from the mobile device 303 to each of the plurality of acoustic receivers 305. Further, the processor 307 may be operable to determine the distance of the mobile device 307 to each of the plurality of acoustic receivers 305 based on a time difference in reception at each of the plurality of acoustic receivers 305 of the acoustic signal, where the acoustic signal is transmitted from the mobile device 305. Further, in embodiments, components or functions of the processor 307 may be part of or performed by the mobile device 303. Accordingly, the mobile device may receive a communication signal from the processor 307 that provides information regarding a time of reception of an acoustic signal at each of the plurality of acoustic receivers 305.

In embodiments where the processor is independent of the mobile device, the battery drain on the mobile device may be lower if signal processing is performed on dedicated hardware powered by a separate power source, such as a vehicle power source. The processor may also be operable to receive a Bluetooth signal transmitted by the mobile device and to transmit a signal to the mobile device. In one embodiment, a Bluetooth Simple Serial Profile SSP may be used to provide a communication signal to the mobile device.

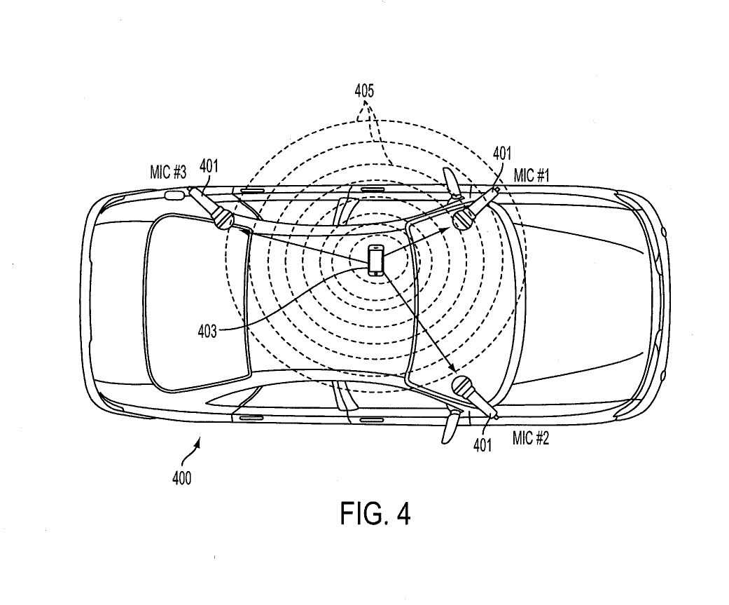

In one embodiment, the plurality of acoustic receivers comprises an array of microphones. The array 401 may be installed in multiple locations inside a cabin of a vehicle 400 as shown in FIG. 4. The system 300 may be configured to listen for an acoustic signal 405, such as a plurality of ultrasonic pulses through the array of microphones 401. Because the distances of the microphones 401 to the mobile device 403 are different, the ultrasonic pulses 405 will arrive at each microphone 401 at a different time. In one embodiment, the arrival time of a pulse is detected using a fixed threshold for initial detection and then applying an optimization routine to obtain a best estimate of the arrival time. Accordingly, the distance of the mobile device 403 to each of the microphones 401 can be calculated from a relative time difference. Once the distances are known, the location of the mobile device 401 can be determined. In one embodiment, the location is determined via triangulation. Additionally, the system 300 may be used to detect multiple mobile devices simultaneously using the components and methods disclosed herein.

In one embodiment, an acoustic receiver, such as a microphone, may implement a high pass filter before an amplifier of the microphone so that most of the sound energy such as conversation, music, road noise below the frequency of the acoustic signal, such as 19 KHz will be filtered. The high pass filter may ensure that the microphone amplifier does not enter saturation state when an area where the location of the microphone, such as a vehicle cabin, is very noisy because if the microphone amplifier enters saturation state, a location of mobile device may be able to be detected reliably. Furthermore, background noise removal may be accomplished by first estimating an amount of background noise and then removing the background noise from the audio signal to prevent erroneous detection.

Additionally, in embodiments, fade in and fade out may applied at the beginning and the end of a transmission of an acoustic signal to minimize popping and whopping sounds caused by the instantaneous charging and discharging of the speaker coil when a high-volume sound is suddenly played on the speaker. In another embodiment, the system may adjust for temperature and humidity effect in the calculation of a physical distance of a mobile device based on speed of sound, which change based on humidity and temperature change in the environment.

In embodiments, the systems and methods of the present disclosure may comprise components that are hardware, software, or combinations thereof. In one embodiment, the software may be an application that is able to be installed on a mobile device, such as a smartphone, tablet, etc. In embodiment, a mobile application may be configured to run on mobile devices such as Android devices, iPhone and various wearable devices.

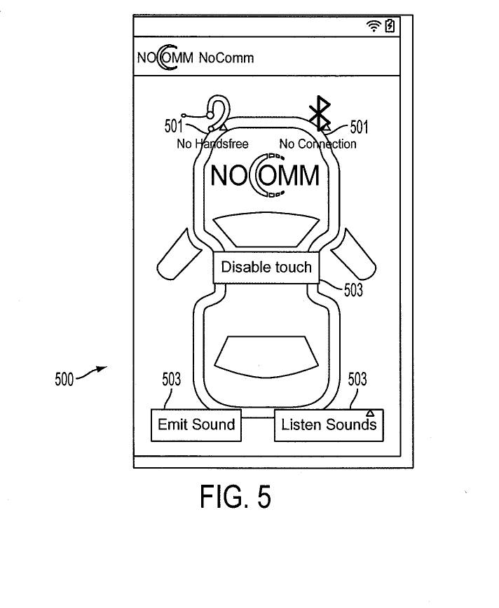

FIG. 5 displays a screen capture of a version of an interface 500 for a mobile application according to an embodiment of the present disclosure that is designed to run on Android operating system. The interface 500 comprises messages 501 regarding a mobile device such as whether a Bluetooth connection is available and whether such a connection is established. Further, the interface 500 comprises icons 503 that may allow a user to interact with the mobile application. In other embodiments, the mobile application may be ported to additional mobile operating systems, such as iOS, Blackberry, Windows Mobile and etc. In embodiments, the hardware may comprise at least three acoustic receivers as described, such as microphones, and an electronic device, such as a processor. The microphones may be installed in the interior of a vehicle and the processor may be an embedded processor installed in the vehicle. This hardware may be designed to work in tandem with a mobile application to perform presence detection, localization, and locking of the mobile device. Referring to FIG. 3, in one embodiment, the mobile application is stored in a memory of the mobile device 303 and is configured to send an acoustic signal through the speaker 309 of the mobile device 303. The acoustic signal, which may be a plurality of 19 KHz pulses, is received through multiple microphones 305 and the processor triangulates the position of the mobile device. If the mobile device 303 is determined to be in the driver zone, the hardware 305, 307 is configured to send a lock message to the mobile application through a Bluetooth connection. The mobile application is configured to lock the screen of the mobile device 303 upon receipt of the lock message.

Advantages of a systems and methods of the present disclosure include:

1) Availability of Ultrasound Friendly Speaker on Smartphone—Because of a consumer's expectation of high fidelity sound from the speaker of a mobile device, such as a smart phone, many mobile devices come equipped with high performance speaker that can output a high volume of ultrasound.

2) Minimal software processing on a mobile device—In embodiments where the processor-intensive location detection algorithm is carried out independent of the mobile device, minimum resource may be required for a software application on a mobile device. This allows the system to run on devices that have constrained processor and battery resources, such as for example Google Glass, smart watch, and low-end smart phones.

3) Robustness—In embodiments where a system/method implements a time of first arrival, the system/method is less prone to the distortion introduced by obstruction, reflection and multi-path effect.

4) Low Interference—audio interferences inside a car cabin have frequency much less than 19 KHz. Road, engine and wind noises are in the hundreds of Hz, human conversation centers around 5 KHz, and music rarely exceeds 13 KHz. Because of the minimal interference in the high frequency audible range, the system/method may be able to achieve better signal to noise ratio, and thus better detection success rate.

5) Unobtrusiveness—Most adult human beings cannot hear frequency above 15 KHz. In one embodiment, a short sound pulse ( 1/10s of a second) emitted by the system should be imperceptible to most drivers and passengers.

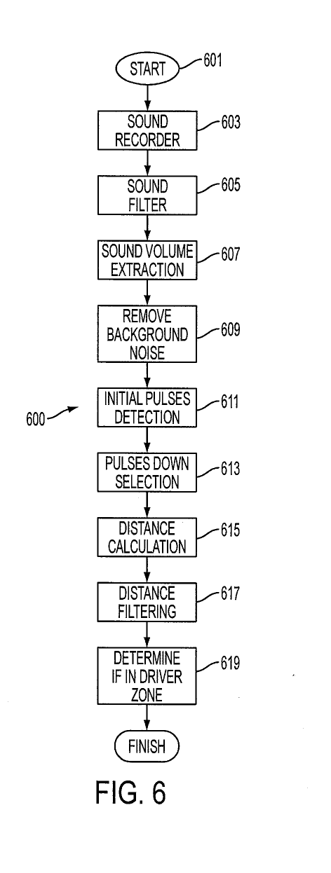

Additional description of embodiments of active detection are provided as follows. In embodiments, the acoustic signal received by the acoustic receivers is converted to an electrical signal and the electrical signal comprises information regarding the acoustic parameters of the acoustic signal. In embodiments, signal processing is performed on the electrical signal to determine a location of mobile device. In embodiments, the systems and methods of the present disclosure may comprise a sound player, a sound recorder, and/or a sound filter as described below that perform particular functions of the necessary signal processing. A method 600 of processing an acoustic signal according to one embodiment of the present disclosure is shown in FIG. 6.

Initially, at step 601, a sound player may periodically play a sound file that contains 19 KHz audio acoustic pulses at high volume through an external speaker of a mobile device. In embodiments, the sound player may a circuit configured to pay the acoustic signal, it may be a mobile application stored on a mobile device, or it may be an application stored on a device in communication with a mobile device. Further, the sound player may be a component of the mobile device or a component of a device in communication with a mobile device. Example code of one embodiment of a sound player is shown below:

public SoundPlayer(Context pContext)
{

// setup Soundpool
mShortPlayer = new SoundPool(4,
AudioManager.STREAM_MUSIC, 0);
mSounds.put(R.raw.ultrasound, this.mShortPlayer.load(pContext,
R.raw.ultrasound, 1));

}
public void emitSound(int piResource) {

```
  int iSoundId = (Integer) mSounds.get(piResource);
  soundPlayingId = mShortPlayer.play(iSoundId, 0.85f, 0.0f, 1000,
  −1, 1.0f);
```

}

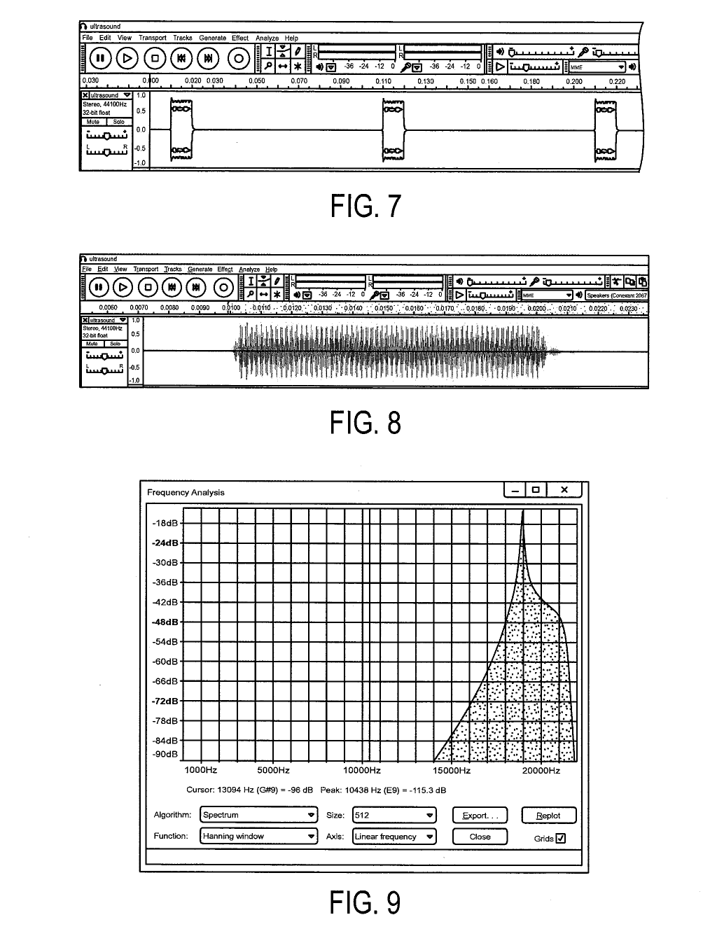

A sound file (R.raw.ultrasound) shown in the code above contains pulses, or beeps, that are 10 milliseconds long and are 19 KHz sinusoidal signals separated by 190ms of silence between the pulses. This sound file may be recorded using 44.1 KHz sampling rate and 32-bit floating number format. FIG. 7 illustrates an acoustic signal that comprises three pulses at 19 kHz. In addition, FIG. 8 provides a close up illustration of a single 19 KHz pulse. Furthermore, FIG. 9 is an illustration of a Fourier transform of an acoustic signal having a single peak at 19 KHz.

At step 603, a sound recorder may capture a short recording from an acoustic receiver at a predetermined sampling frequency. In one embodiment, the sampling frequency is 44.1 KHz. Further, in an embodiment, the recorded audio is converted to an array of double precision floating number for further analysis. Example code of an embodiment for capturing a recording is shown below:

```
int frequency = 44100;
int blockSize = 22050;
int channelConfiguration = AudioFormat.CHANNEL_IN_MONO;
int audioEncoding = AudioFormat.ENCODING_PCM_16BIT;
audioRecord = new
AudioRecord(MediaRecorder.AudioSource.CAMCORDER, frequency,
channelConfiguration,audioEncoding, blockSize * 2);
// start recording until explicitly stopped
while (getNoCommApplication( ).isListeningSounds( )) {
  recData = new ByteArrayOutputStream( );
  dos = new DataOutputStream(recData);
  short[ ] buffer = new short[blockSize];
  audioRecord.startRecording( );
  int bufferReadResult = audioRecord.read(buffer, 0, blockSize);
  for (int i = 0; i < bufferReadResult; i++) {
```

try {

dos.writeShort(buffer[i]);

} catch (IOException e) {

e.printStackTrace( );

}

```
  }
  audioRecord.stop( );
  try {
```

dos.flush( );
dos.close( );

} catch (IOException e1) {

e1.printStackTrace( );

```
  }
  byte[ ] clipData = recData.toByteArray( );
  ByteBuffer rawByteBuffer = ByteBuffer.wrap(clipData);
  rawByteBuffer.order(ByteOrder.BIG_ENDIAN);
  double[ ] micBufferData = new double[clipData.length / 2];
  for (int i = 0; i < clipData.length; i += 2) {
```

short sample = (short) ((clipData[i] << 8) + clipData[i + 1]);
micBufferData[i / 2] = (double) sample / 32768.0;

}

Further, at step 605, a sound filter may apply a narrow band-pass filter centered at 19 KHz to emphasis the acoustic signal. In one embodiment, the sound filter comprises a Butterworth Infinite Impulse Response filter (Butterworth-type IIR filter). Example code for a Butterworth-type IIR filter is shown below:

private IirFilterCoefficients filterCoefficients;
private IirFilter filter;
filterCoefficients = new IirFilterCoefficients( );
filterCoefficients.a = new double[ ] { 1.0000000000000000E+0,
1.7547191342863953E+0, 9.3451485937250567E−1 };
filterCoefficients.b = new double[ ] { 2.5671973749246350E−2,
0.0000000000000000E+0, −2.5671973749246350E−2 };
filter = new IirFilter(filterCoefficients);
double[ ] filterOutput = new double[micBufferData.length];
for (int i = 0; i < micBufferData.length; i++) {

filterOutput[i] = filter.step(micBufferData[i]);

}

Further, an IIR filter is one embodiment of a plurality of different embodiments of filter implementations. Depending on a particular operating system of a mobile device, a software library, and/or a particular hardware resource; a type of IIR and/or Finite Impulse Response (FIR) filter may be chosen as appropriate.

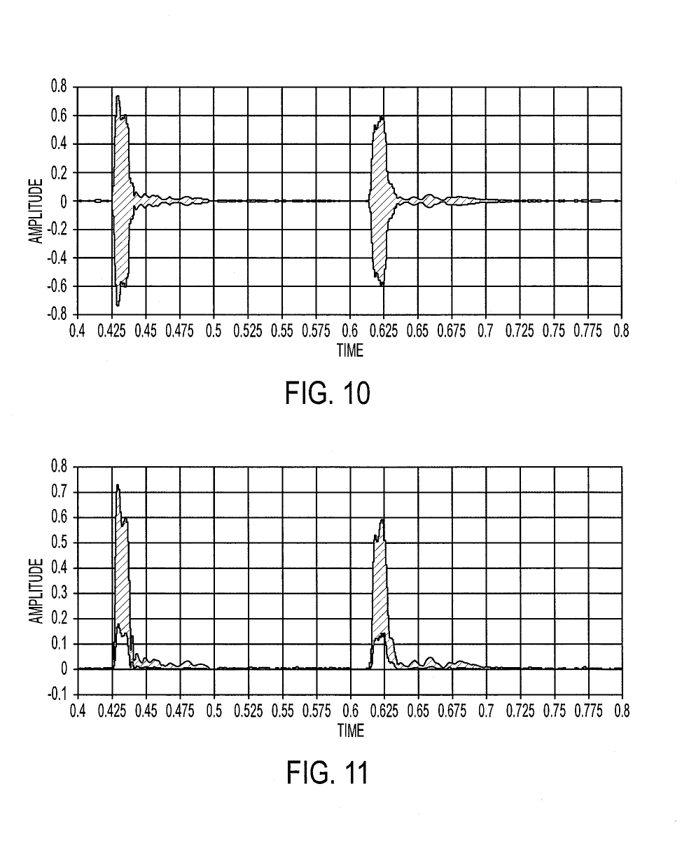

In one embodiment, an acoustic receiver, such as a microphone, records the acoustic signal as oscillations around the 0-axis. A volume value, which is always greater or equal to 0, may be extracted from the sound recording at step 607 for the purpose of efficient analysis. FIGS. 10 and 11 illustrate an embodiment of the volume extraction process. FIG. 10 illustrates an input sound recording that comprises two pulses and FIG. 11 illustrates extracted volume data of the two pulses. The recording is shown in FIG. 10 as having positive and negative values due to the oscillatory nature of a sound wave. Sound volume extraction may be done by calculating the 7-elements moving average of the absolute values of the sound volume. Example code of an embodiment for sound volume extraction is shown below:

double soundVolume[ ] = new double[filterOutput.length];
for (int i = 6; i < filterOutput.length; i++) {
soundVolume[i] = Math.abs(filterOutput[i]) + Math.abs(filterOutput[i − 1])

+ Math.abs(filterOutput[i − 2]) + Math.abs(filterOutput[i − 3])
+ Math.abs(filterOutput[i − 4]) + Math.abs(filterOutput[i − 5])
+ Math.abs(filterOutput[i − 6]);

}

Due to possible interference, filtering artifacts, electronic noise and transducer distortions, it may be necessary to remove background noise from the volume data at step 609. To remove background noise, a fixed threshold may be applied to each element of the volume data. If the volume data is less than the threshold, it may be assigned a value of 0. Example code of applying a threshold to volume data is shown below:

private final double NOISE_MAX_VOLUME = 0.05;
for (int i = 0; i < soundVolume.length; i++) {
// If sound volume < NOISE_MAX_VOLUME, then set volume to 0.
if (soundVolume[i] < NOISE_MAX_VOLUME) {

soundVolume[i] = 0.0;

}

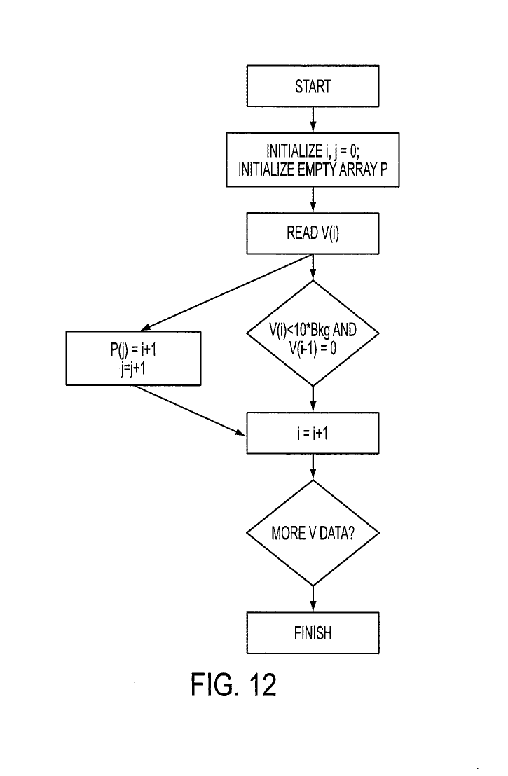

Sounds with an energy level that is significantly higher than the background noise, which may be referred to as pulses, beeps, or peaks, and are potential candidates for identifying pulses at step 611. FIG. 12 demonstrates a method for identifying the starting time of sound pulses. The method for the pulse detection may be a fixed threshold technique according to the example code shown below:

C++ Psuedo Code

| | |
|---|---|
| double noise_free_volume[ ]; | //input |
| int initial_cross_over_points[ ]; | //output, time index where volume |
| | first change from zero to non-zero. |
| int i,j=0; | |

for (i=1;i<sizeof(noise_free_volume);i++) {

if (noise_free_volume[i−1]==0 && noise_free_volume[i]>0) {

initial_cross_points[j]=i;
j++;

}

}

Below is example code that may be implemented for pulse detection according to the method shown in FIG. 12:

```
for (int i = ; i < soundVolume.length; i++) {
  if (soundVolume[i] < NOISE_MAX_VOLUME) {
    continue;
  }
  int j = ;
  double max = ;
  for (j = i; j < soundVolume.length; j++) {
    if (soundVolume[j] > max)
      max = soundVolume[j];
    if (soundVolume[j] < NOISE_MAX_VOLUME) {
      j++;
      break;
    }
  }
  int count = j − i;
  if (max < NOISE_TRESHHOLD) {
    for (j = ; j < count; j++) {
      soundVolume[i + j] = .;
    }
  } else {
    double peakTreshold = .1 * max;
    for (j = ; j < count; j++) {
      if (soundVolume[i + j] >= peakThreshold) {
        peaks.add(i + j);
        soundVolume[i + j]= −1.;
        break;
      }
    }
  }
  i += count − 1;
}
```

A process of initial pulse detection performed at step 611 may produce a list of time stamps of sound pulses. As part of a previous step, the list may be filtered by eliminating sound pulses that are very close to or very far from earlier pulses according to a pulses down selection process performed at step 613. In one embodiment, if a time difference between a pulse and a preceding pulse or a proceeding pulse is not in a range specified by a minimum and maximum value, then the pulse may be eliminated from the list of time stamps. Accordingly, if a pulse is not within a predetermined range, it may be determined to be a reverberation of an earlier pulse instead of a new pulse. Example code for determining time differences of pulses in the list is shown below:

if (peaks.size( ) > 1) {

List<Integer> differences = new ArrayList<Integer>( );
int i,j=0;
for (i = 0; i < peaks.size( ); i++) {

for (j=i; j<peaks.size( );j++)
{

int diff = peaks.get(j) − peaks.get(i);
if (diff >= minDist && diff <= maxDist) {

int distInSamples = diff − midDist;
double dist = distInSamples * (34 / 44.1);
double time = diff / 44.1;
differences.add(diff);
break;

}

}

The relative location of the mobile device may then be calculated using the speed of sound in step 615 using the following formula:

$$Relative Distance ( cm ) = - 0.5 * 34.3 \frac{cm}{s} \cdot ( length of silence between pings - 190 ms )$$

$$Relative Distance ( cm ) = - 0.5 * 34.3 \frac{cm}{s} \cdot ( 189.2066 - 190 ) = - 14 cm$$

Example code of an embodiment for calculating a relative location of a mobile device is shown below:

int distInSamples = diff − midDist;
double dist = distInSamples * (34 / 44.1);
double time = diff / 44.1;

The value “34” shown above is the speed of sound in cm/ms. The value “44.1” is the number of audio samples in 1 millisecond at the sampling frequency of 44.1 KHz. In addition, there are many sources of error that might lead to incorrect calculated distance from time to time. To eliminate statistical outliers, distance filtering may be applied at step 617 based on a calculated distance that may be averaged over current values and a finite set of historical values. A moving average process may improve the accuracy at the expense of slower detection speed (˜10 seconds). Example code below illustrates one embodiment of a moving average filtering calculation:

if (!differences.isEmpty( )) {

int sumDiff = 0;
for (int diff : differences) {

sumDiff += cliff;

}

int averageDiff = sumDiff / differences.size( );

Ultimately, a determination is made as to whether a mobile device is located in a predetermined detection zone in step 619; such as a driver's zone. For the implementation shown above, a mobile device may be considered to be in a predetermined detection zone when a relative position is greater than 0. In an embodiment, this means if a relative placement is to the left of a mid-point of a vehicle cabin, then a mobile device may be determined to be in a driver's seat location. Example code of an embodiment for determining a relative position is shown below:

private void calculateDeviceDistance( ) {

int sum = 0;
for (Peaks setOfPeaks : setsOfPeaks) {

sum += setOfPeaks.getDifferenceInSamples( );

}
int average = sum / setsOfPeaks.size( );
int differenceFromMiddle = average − midDist;
int differenceInSamples = Math.abs(differenceFromMiddle);
double positionInCm = differenceInSamples * (34 / 44.1);
if (differenceFromMiddle > 0) {

sendLockDeviceMessage( );

} else {

sendUnlockDeviceMessage( );
}

}

Further, according to one embodiment, a communication channel of a mobile device may be monitored for a lock message. In one embodiment, a Bluetooth message may be transmitted to a mobile device. In one embodiment, the message may be sent from inside of a cabin of the vehicle and if a lock message is received, the mobile device may commence a process to inhibit a function of the mobile device. This may include locking a screen of the device. Example code of one embodiment of a message to lock a mobile device is shown below:

if (message.equals(“lock\n”)) {

if (!getNoCommApplication( ).isPausedSoundPlaying( )) {

sendLockDeviceMessage( );
timer.cancel( );
timer.start( );

}

In one embodiment, the lock message may be continuously transmitted while the mobile device is determined to be within the predetermined detection zone. In addition, in one embodiment, a timer associated with the mobile device may be implemented such that as the timer runs out, a determination is made whether the lock message has been received again.

Accordingly, if the timer runs out and the lock message is not received again, this may be an indication that a mobile device has been moved from a predetermined detection zone. Then the at least one function of the mobile device may be restored.

In addition, various embodiments of the sound filter discussed above with regard to step 605 of FIG. 6 are described below. In embodiments, analog electronic components such as capacitor, resistor, inductors and amplifiers can be used to build band pass filter. Infinite impulse response (IIR) and finite impulse response (FIR) are two common types of digital filters. Depending on a particular mathematical equation, the following filters can be used to produce the desired band pass properties:

1) Butterworth;

2) Chebyshev;

3) Bessel; or

4) Elliptical.

There are also many popular circuit implementations of various band pass filters, including:

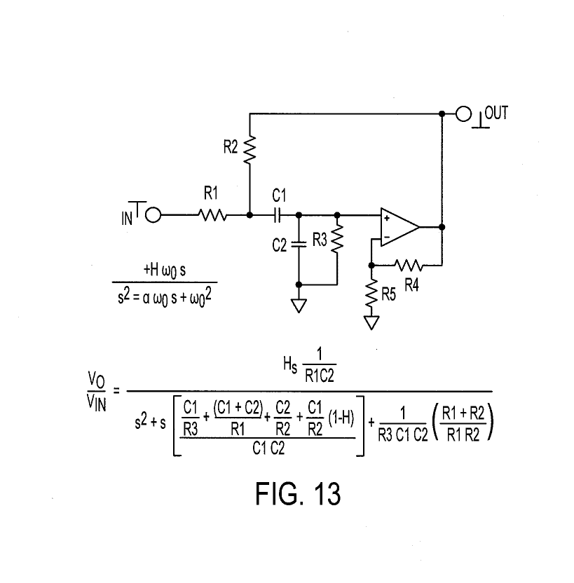

1) Sallen-Key filter as shown in FIG. 13;

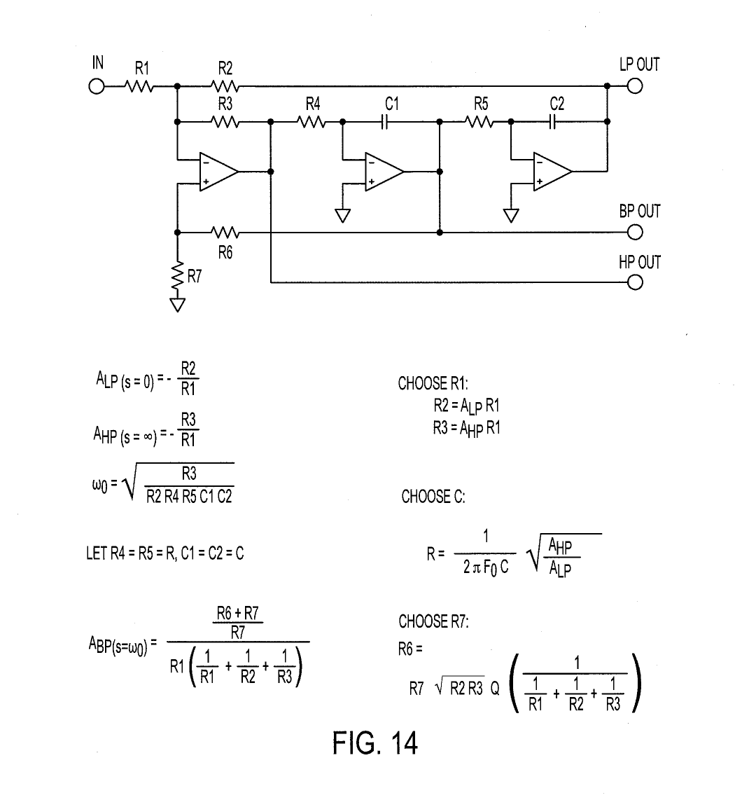

2) State Variable filter as shown in FIG. 14;

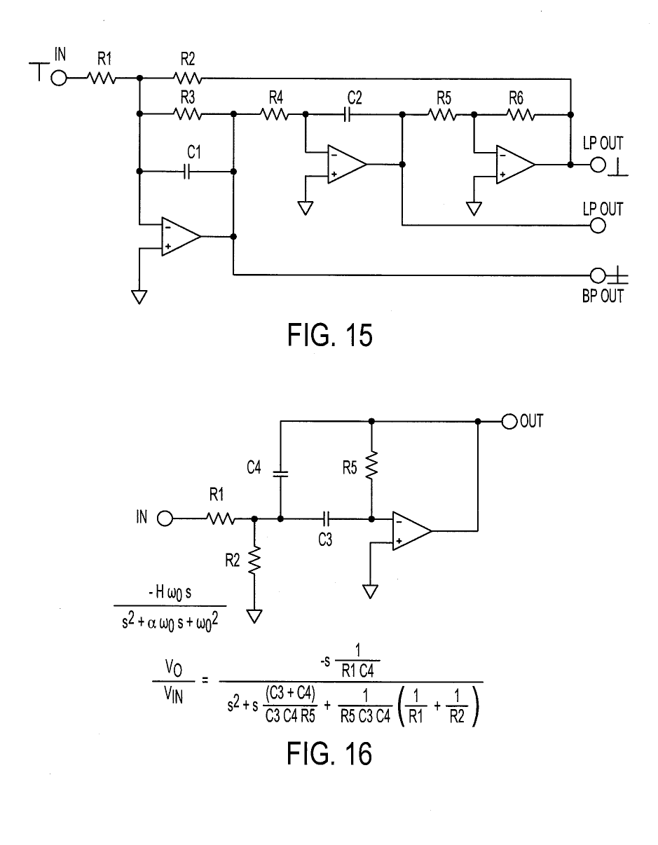

3) Biquadratic (Biquad) filter as shown in FIG. 15;

4) Multiple Feedback Bandpass filter as shown in FIG. 16; and

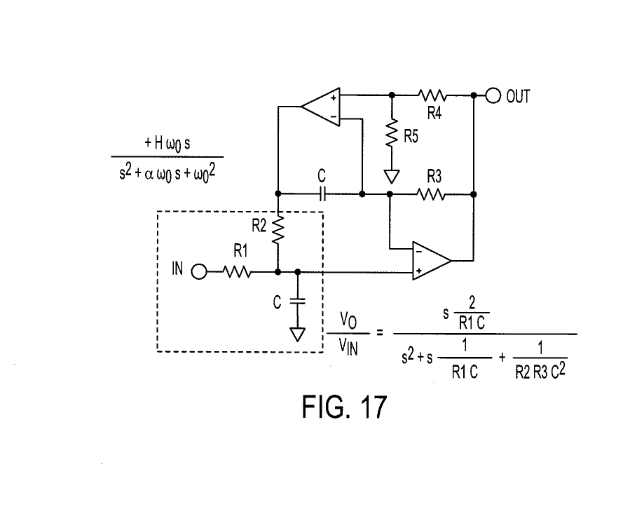

5) Dual Amplifiers Band-Pass (DAPB) filter as shown in FIG. 17.

Further, embodiments of sound filters may be implemented using a microprocessor Field Programmable Gate Array (FPGA) or a Digital Signal Processor (DSP).

Additionally, embodiments of sound volume extraction discussed above are described below. A demodulation process used by Amplitude Modulation (AM) radio receiver may be used for extracting sound volume from an ultrasonic pulse. Accordingly, various analog implementations of an AM radio demodulator may be used to extract the volume information from a 19 KHz ultrasonic carrier frequency. The following is a list of AM demodulation techniques:

1) Envelope detector consisting of rectifier and low pass filter;

2) Crystal demodulator; and

3) Product detector.

In addition, a Hibert Transform may be used for volume extraction. Further, a dedicated Application Specific Integrated Circuit, or ASIC semiconductor chip, may be used to detect the volume level from audio signal. One example is a THAT 2252 RMS-Level Detector chip manufactured by THAT Corporation.

Moreover, embodiments of pulse detection as discussed above are described below. Pulse detection may be considered as a problem studied across various academic fields. The operation may be to separate out a true signal, which is referred to as a ping, from noise. One embodiment of pulse detection functions to separate a ping from noise is when the volume information exceeds fixed multiples of the background noise. Another embodiment of pulse detection according to the present disclosure involves using a Cumulative Sum (CUSUM) chart. The CUSUM may be used to discern significant deviation from natural variability in continuous evolving process. In addition, an Otsu threshold can be applied to identify a ping (foreground) from noise (background). The algorithm assumes that an acoustic signal follows a bi-modal histogram consists of ping (foreground) and noise (background). By dividing each time slice into two groups (ping and noise), while minimizing the variance within each group, a ping may be identified reliably even with varying noise level.

Additionally, steps 6 through 9 of the method shown in FIG. 6 may be substituted in whole or in part using a time delay cross correlation technique or phase correlation. A relative delay, or phase shift, of the acoustic signals received at each microphone can be calculated using phase correlation. Once the phase shifts of the microphones are determined, the relative placement of the acoustic source can be determined.

The following equations illustrate the calculation of phase correlation between the acoustic data from two microphones, s1 and s2:

1) Calculate a Fourier transform of both time-series acoustic signals s1, s2;

2) Calculate a complex conjugate of a second Fourier transformed signal, S2, and then multiply it with Si to calculate a cross-power spectrum R;

3) Apply an inverse Fourier transform to R; and

4) The phase shift is calculated as a peak in r due to the Fourier-shift theorem.

Once phase shift has been determined, the relative location can be calculated by multiplying the phase shift by the speed of sound.

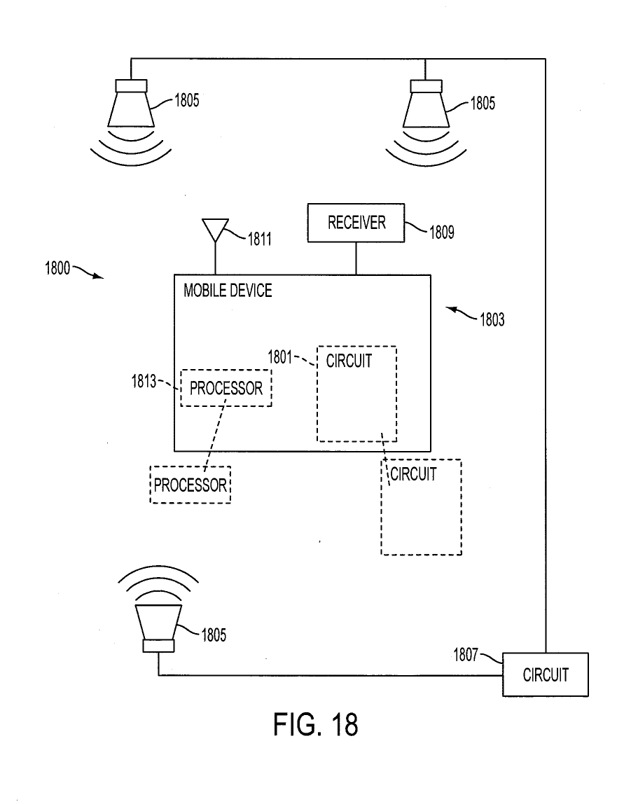

As shown in FIG. 18, in one embodiment of a theory of the present disclosure, which may be referred to as passive detection, a system 1800 for determining a presence of a mobile device located in a predetermined detection zone comprises a plurality of transmitters 1805, where each of the plurality of transmitters 1805 is configured to transmit an acoustic signal, a mobile device 1803 configured to receive each acoustic signal transmitted by the plurality of transmitters 1805, and a processor 1813 configured to determine a location of the mobile device 1803 based on the acoustic signals transmitted by the plurality of transmitters 1805 and received by the mobile device 1803 and to determine whether the location of the mobile device 1803 matches the predetermined detection zone. The processor 1813 may also be configured to cause the mobile device 1803 to inhibit at least one function of the mobile device 1803 upon determining that the location of the mobile device 1803 matches the predetermined detection zone.

In embodiments, the system 1800 may use the Time of Arrival (TOA) of the acoustic signal for detection of the mobile device 1803 and to determine whether the mobile device 1803 is in a driver side location of a vehicle. The acoustic signal may comprise at least one sonic pulse, which may be an ultrasonic pulse. In one embodiment, the at least one ultrasonic pulse is transmitted at a range of 15 KHz to 25 KHz. In another embodiment, the at least one ultrasonic pulse is transmitted at a range of 18 KHz to 20 KHz. In a further embodiment, the at least one ultrasonic pulse is transmitted at 19 KHz. Using a narrow-bandwidth 19 KHz acoustic pulse or beep may allow for aggressive digital filtering to attenuate background noise. Furthermore, a narrow-bandwidth 19 KHz acoustic pulse or beep may improve localization sensitivity over a range of frequencies since a wider bandwidth may contain more noise in a pass band directed to such a range of frequencies. Additionally, using a narrow-bandwidth 19 KHz acoustic pulse or beep may allow for transmission at a lower acoustic volume.

In embodiments, ultrasonic pulses may be transmitted from the mobile device 1803, through a wireless channel, to the acoustic transmitters 1805 via circuit 1807. The acoustic transmitters 1805 and circuit 1807 may be implemented as the audio system of a vehicle with a multi-channel surround sound system. The signal may be transmitted via an antenna 811 of the mobile device 1803. The antenna 1811 may be a component of the primary communication scheme of the mobile device 1803 or a component of a secondary communication scheme of the mobile device 1803, such as Bluetooth. In such an example, installment of dedicated speakers may not be necessary.

The system 1800 may also comprise circuit 1801 may be configured to inhibit at least one function of the mobile device 1803. The processor 1813 may be in communication with the circuit 1801 of the mobile device. As shown in the embodiment of FIG. 18, the circuit 1801 may be located within the mobile device 1803 or it may be communicatively coupled to the mobile device 1803 such that control and/or command signals can be exchanged between the circuit 1801 and the mobile device 1803. Similarly, as shown in the embodiment of FIG. 18, the processor 1813 may be located within the mobile device 1803 or it may be communicatively coupled to the mobile device 1803 such that information may be exchanged between the processor 1813 and the mobile device 1803.

Furthermore, in embodiments, the circuit 1801 may comprise a control module associated with the mobile device 1803, where the control module 1801 is coupled to a non-transitory memory that stores executable instructions, wherein the control module 1801 is operable to execute the instructions stored in the memory. The control module 1801 may be operable to receive a command signal from a processor 1813 and inhibit at least one function of the mobile device 1803 upon reception of the command signal. As shown in FIG. 18, in one embodiment, the control module 1801 may be located within the mobile device 1803. In another embodiment, the control module 1801 may be in communication with the mobile device through a communication network, such as a wireless communication network. The control module 1801 may also be configured to inhibit the at least one function of the mobile device 1803 upon the processor 1813 determining that the location of the mobile device 1803 matches the predetermined detection zone. The control module 1801 may also be configured to redirect at least one function of the mobile device 1803 to a hands-free alternate system upon the processor 1813 determining that the location of the mobile device 1803 matches the predetermined detection zone.

During embodiments of passive detection, each speaker 1805 may be configured to emit an acoustic signal that comprises short pulse of a high frequency sound signal. The mobile device 1803 may be configured to capture the acoustic signal via an acoustic receiver 1809, such as a microphone of the mobile device 1803. The processor 1813 may be configured to calculate a time-of-flight of the acoustic signal and determine a location of the mobile device 1803 in reference to a predetermined detection zone based on the time-of-flight.

Once a determination is made by the processor 1813 as to whether the mobile device 1803 is within the predetermined detection zone, the processor 1813 may cause a signal to be sent to the mobile device 1803 for inhibiting a function of the mobile device 1803. The signal may be received via an antenna 1811 of the mobile device 1803. Once an appropriate signal is received, operation of the mobile device 1803 may be controlled in one or more ways. For example, in one embodiment, the mobile device 1803 is associated with control module 1801 that disables or inhibits the operation of at least one function of the mobile device 1803. Thus the mobile device 1803 is rendered either inoperable or operable only in a state of limited capacity. Accordingly, the control module 1801 may be able to either completely block the ability to receive or send a call on a mobile device 1803, or sufficiently interfere with a function of the mobile device 1803 so as to make the mobile device 1803 usage undesirable. In embodiments, the control module 1801 may disable the operation of certain components or functions of the mobile device. For example, a keyboard portion of a mobile device 1801 may be disabled to prevent the user from using a text messaging function or an email function of the mobile device. In another embodiment, the control module 1801 may direct the operation of the mobile device 1803 to a hands-free operation. In another embodiment, outgoing communication functions may be inhibited, but incoming communication functions may be uninhibited. In another embodiment, automatic replies may be initiated during a period in which a function of the mobile device 1803 is inhibited.

In embodiments, the processor 1813 may be coupled to a non-transitory memory that stores executable instructions, and the processor 1813 may be operable to execute the instructions. The processor 1813 may be operable to execute the instructions to receive the an electrical signals from an acoustic receiver 1809 of the mobile device 1803, where each electrical signal is based on each acoustic signal received by the acoustic receivers 1809, to determine a location of the mobile device 1803 based on the time of reception of the acoustic signals by the acoustic receiver 1809, and to determine whether the location of the mobile device 1803 matches the predetermined detection zone. In one embodiment, the processor 1813 is operable to determine the location of the mobile device 1803 based on a distance from the mobile device 1803 to each of the plurality of acoustic transmitters 1805. Further, the processor 1813 may be operable to determine the distance of the mobile device 1803 to each of the plurality of acoustic transmitters 1805 based on a time difference in transmission from each of the plurality of acoustic transmitters 1805 of the acoustic signals. In one embodiment, the processor 1813 is a mobile application processor. Further, in one embodiment, the processor 1813 may be located within the mobile device and in another embodiment, the processor 1813 may be independent of the mobile device 1803 and communicatively coupled to the mobile device 1803. Further, in embodiments, components or functions of the processor 1813 may be part of or performed by the mobile device 1803. Accordingly, the mobile device may receive a communication signal from the processor 1813 that provides information regarding a time of reception of each acoustic signal at the acoustic receivers 1809 of the mobile device 1803

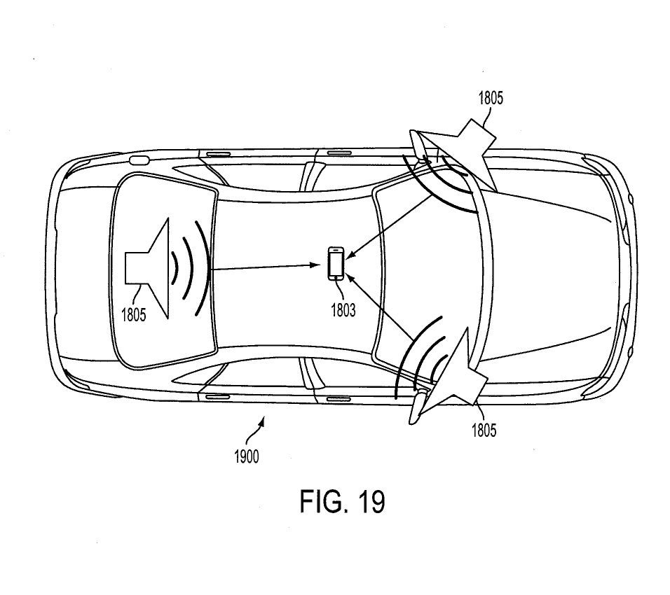

The plurality of transmitters 1805 may be a plurality of acoustic transmitters, such as speakers, located inside of a cabin of a vehicle. One embodiment of a location of the speakers 1805 is shown in FIG. 19. The speakers 1805 may be dedicated and integrated with the vehicle when the vehicle is manufactured, or the speakers may be added to the vehicle. In one embodiment, the speakers 1805 may be dedicated speakers that optimized for high frequency sounds transmission. In one embodiment, the speakers 1805 may be a special type of loudspeaker (usually dome or horn-type) designed to produce high audio frequencies, such as a Tweeter. Further, the system 1800 may employ two or more speakers 1805. In one embodiment, three or more speakers may be implemented to provide ultrasonic pulses or pings.

In addition, a method for determining a presence of a mobile device located in a predetermined detection zone comprises transmitting a sequence of acoustic pulses is transmitted through multiple acoustic transmitters, for example a plurality of speakers 1805. Each pulse may be transmitted at 19 KHz and may be separated from another pulse by a pre-defined amount of time delay. The sound received at the acoustic receiver of the mobile device 1803 may be recorded. The acoustic signal from each speaker is identified and the time difference between each pulse is analyzed. Based on the time difference between the pulse, a relative distance is calculated to each speaker and a determination is made as to whether the mobile device is in the driver zone or not.

Additional description of embodiments of passive detection is provided. In embodiments, the acoustic signal received by the acoustic receiver of the mobile device is converted to an electrical signal and the electrical signal comprises information regarding the acoustic parameters of the acoustic signal. In embodiments, processing is performed on the electrical signal to determine a location of mobile device. In embodiments, the systems and methods of the present disclosure may comprise a sound player, a sound recorder, and/or a sound filter as described with regard to FIG. 6 that perform particular functions of the necessary signal processing. In embodiments, the signal processing components and functions described for passive detection may be implemented in the same or similar fashion in embodiments of active detection described above with regard to FIGS. 6-17 and associated descriptions. Furthermore, the signal processing components and functions described may be implemented by a processor device located within the mobile device or by a processor device in communication with the mobile device.

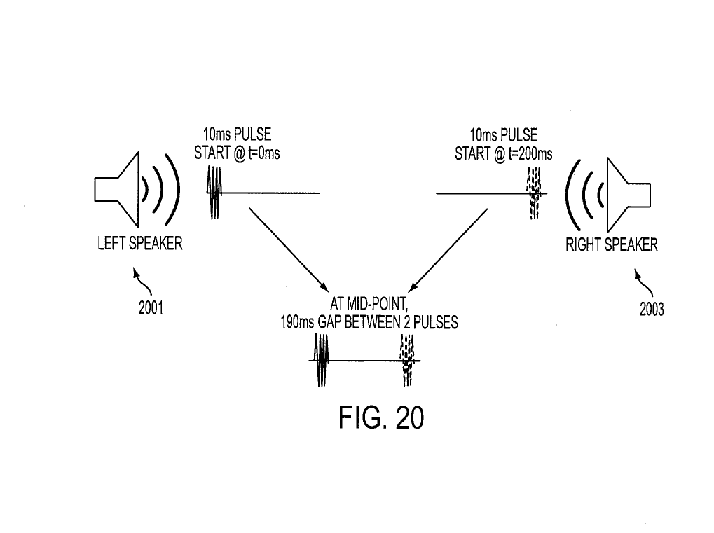

In addition, as with active detection, in passive detection a relative location of a mobile device can be calculated using the speed of sound. The following illustrates one embodiment of a calculation process. In the example of FIG. 20, two speakers are shown, a left speaker 2001 and a right speaker 2003. At time t₀=0, the left speaker 2001 emits a pulse. At time t₀+tₚᵤₗₛₑ+t_{silence}=200 ms, the right speaker 2003 emits a pulse. t_{silence} is set to equal 190 ms.

The mid-point between the two speakers 2001, 2003 is a distance of m from each speaker. The mobile device is calculated to be a distance of d right of the center point between left and right speaker 2001, 2003. The speed of sound is v. The distance of the mobile device to the right speaker 2003 is (m-d). Distance of the mobile device to the left speaker 2001 is (m+d).

For the first pulse from the left speaker, it will be:

$$First detected at t = 0 + ( m + d ) / v ( rising edge of the {1}^{st} pulse )$$

$$\begin{matrix}Last detected at t = {t}_{pulse} + ( m + d ) / v ( falling edge of the {1}^{st} pulse ) \\ = 10 + ( m + d ) / v\end{matrix}$$

For the second pulse from the right speaker, it will be:

$$\begin{matrix}First detected at t = 0 + {t}_{pulse} + {t}_{silence} + ( m - d ) / v ( rising edge of the {2}^{nd} pulse ) \\ = 0 + 10 + 190 + ( m - d ) / v = 200 + ( m - d ) / v\end{matrix}$$

$$\begin{matrix}Last detected at t = 0 + {t}_{pulse} + {t}_{silence} + {t}_{pulse} ( m + d ) / v ( falling edge of the {2}^{nd} pulse ) \\ = 210 + ( m - d ) / v\end{matrix}$$

The silence between the two pulses, specifically, from the falling edge of the 1^{st} pulse to the rising edge of the 2^{nd} pulses is measured:

$$\begin{matrix}{T}_{silence} = falling edge of {2}^{nd} pulse - rising edge of the {1}^{st} pulse \\ = 200 + ( m - d ) / v - ( 10 + ( m + d ) / v )\end{matrix}$$

$${T}_{silence} = 190 - 2 d / v$$

$${T}_{silence} - 190 = - 2 d / v \\ - 0.5 * ( {T}_{silence} - 190 ) * v = d$$

Therefore, the relative distance d from the center point can be calculated by finding the small shift in the silence period between the two pulses.

$$Relative Distance ( cm ) = - 0.5 * 34.3 \frac{cm}{s} \cdot ( length of silence between pings - 190 ms )$$

$$Relative Distance ( cm ) = - 0.5 * 34.3 \frac{cm}{s} \cdot ( 189.2066 - 190 ) = - 14 cm$$

In the above example, the relative placement is −14 cm, or 14 cm to the right of the midpoint between the two speakers 2001, 2003.

Additionally, a method for determining a presence of a mobile device located in a predetermined detection zone comprises transmitting, by each of a plurality of transmitters, acoustic signals to the mobile device, receiving, by the mobile device, each acoustic signal transmitted by the plurality of transmitters, determining, by a processor, a location of the mobile device based on the communication signals transmitted by the plurality of transmitters and received by the mobile device, determining whether the location of the mobile device matches the predetermined detection zone, and inhibiting at least one function of the mobile device upon determining that the location of the mobile device matches the predetermined detection zone. Each of the acoustic signals comprises at least one ultrasonic pulse at 19 kHz.

Further, determining the location of the mobile device may comprise determining the location of the mobile device based on a distance from the mobile device to each of the plurality of receivers and the distance of the mobile device to each of the plurality of receivers is may be determined based on time difference in reception at each of the plurality of receivers of the acoustic signal transmitted from the mobile device. Additionally determining the location of the mobile device comprises determining the location of the mobile device based on triangulation.

In addition, an acoustic signal may be transmitted by a plurality of acoustic transmitters with additional location or identification information that allows each of the acoustic transmitters to be identified based on information contained in the acoustic signal. In one embodiment, information is encoded using pulse compression by modulating the transmitted acoustic signal and then correlating the received signal with the transmitted acoustic signal. The modulated acoustic signal may be transmitted according to certain parameters such that signal processing is accomplished the same as or similar to the processes described above.

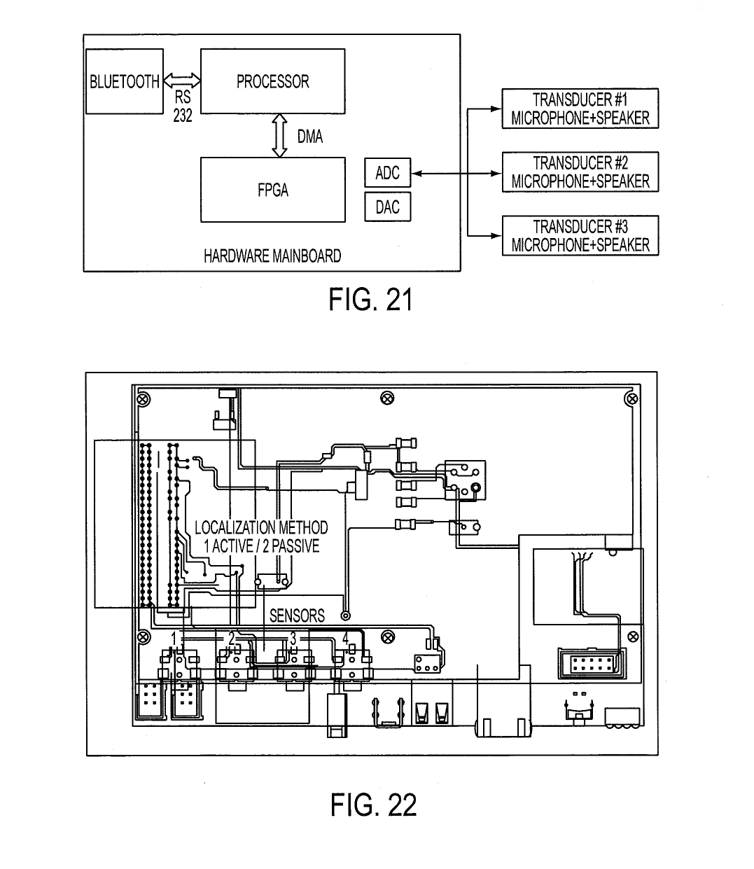

A custom electronic hardware device was built to demonstrate the feasibility of the system. The hardware device consists of electronic main boards including a Freescale PowerPC Microprocessor, a Xilinx Sparta-6 FPGA and custom breakout board, and three transducer boards that hosts ultrasonic microphone and speaker. FIG. 21 is an illustration of components of the custom electronic hardware device.

The main board included the following components:

1) 400 MHz Freescale PowerPC Microprocessor

2) Xilinx Spartan-6 LX45 FPGA
a. 43,576 flip-flops
b. 27,288 LUTs
c. 58 DSP48s
d. 2,088 kbits SRAM
e. 5 DMA channels

3) RS-232 DTE Serial port
a. 230,400 bps
b. 5,6,7,8 data bits
c. 1,2 stop bits
d. Odd, Even, Mar, Space or None parity
e. RTS/CTS, XON/XOFF, DTR/DST, or None flow control

4) Roving Network/Microchip RN42SM Bluetooth module

5) 96 Digital Inputs/outputs
a. 3 mA maximum current per channel
b. 288 mA total currents over all channels
c. VIL=OV min; 0.8V Max
d. VIH=2.0V min, 3.465V max
e. VOH=2.4V min, 3.465V max
f. VOL=0.0V min; 0.4V max

6) 16 SE or 8 DIFF Analog Inputs
a. 16 bits ADC Resolution
b. 200 kS/s maximum aggregate sampling rate
c. +−10V, +−5V, +−2V, +−1 V input voltage range
d. Input impedance=1 GΩ
e. 0.042% error at 25oC, up to 0.38% error at −40 to 85oC.

7) 4 Analog Outputs
a. 12 bits DAC resolution
b. 336 kS/s max update rage
c. 0-5 V range
d. 13Ω output impedance
e. 1 mA drive current

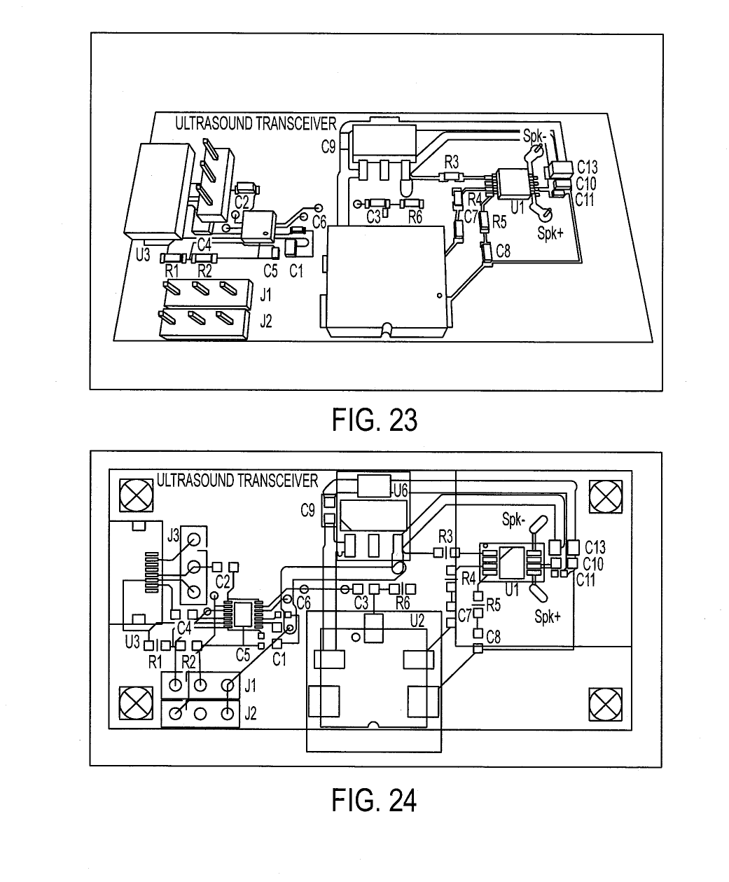

FIG. 22 is a screen capture of the board design of the custom breakout board in Ultiboard CAD software. Further, in the custom electronic hardware device there were three transducer boards connected to each electronic main board via electrical cable. FIG. 23 is a 3D preview of a transducer board according to the implementation and FIG. 24 is a circuit board layout of a transducer board according to the implementation. In the demonstration, the transducer boards were installed in three separate locations inside the vehicle cabin. Transducer board #1 was installed in the front and left of the driver seat; Transducer board #2 was installed in the front and right of the driver seat; and Transducer board #3 was installed behind the driver seat to the left.

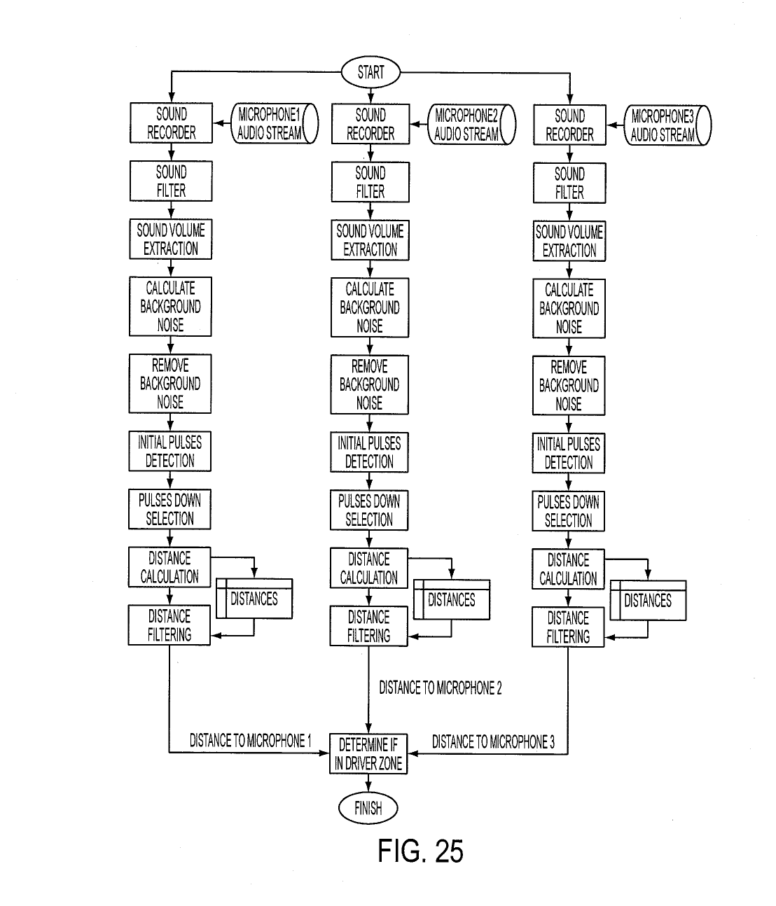

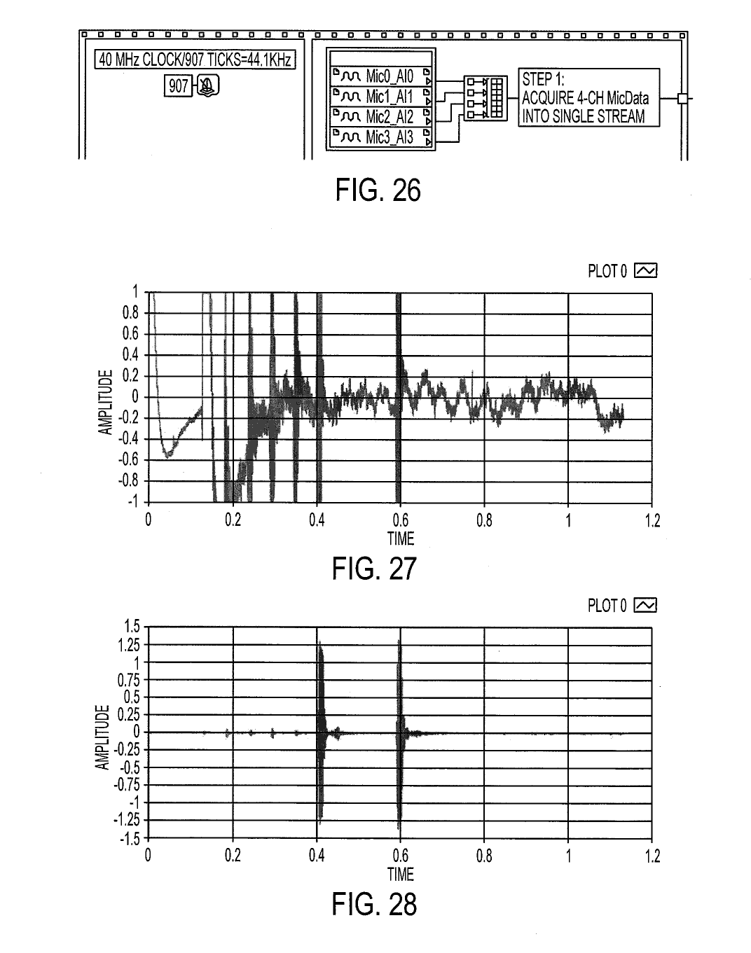

FIG. 25 is a high-level illustration of the implementation, which used active detection and is similar to the method discussed with regard to FIG. 6. An embodiment of a sound recorder was implemented in Spartan-6 LX45 FPGA. FIG. 26 shows an example implementation using LabView FPGA design language. It is noted that the example shown in FIG. 26 illustrates acquisition of audio signal from four microphones when only three microphones may be required for localization of a driver zone. As discussed, in embodiments, more than four microphones may be used as well. Additional microphones may provide redundancy in a location detection algorithm. For example, if one microphone fails and the system can still correctly detect the location using the remaining microphones.

Key characteristics of the embodiment shown in FIG. 25 and provided in the implementation were:

1) Acquisition rate was 44.1 KHz, or every 907 cycles on a 40 MHz FPGA clock. According to a Nyquist—Shannon sampling theorem, sound with frequency up to 22 KHz can be resolved with 44 KHz sampling frequency. Practically, the detection of sound is limited by the sensitivity of the microphones, which may have a high limit around 20 KHz;

2) Data from four microphones was read in parallel as fixed-point precision number; and

3) Read data was then inter-leaved into a single stream.

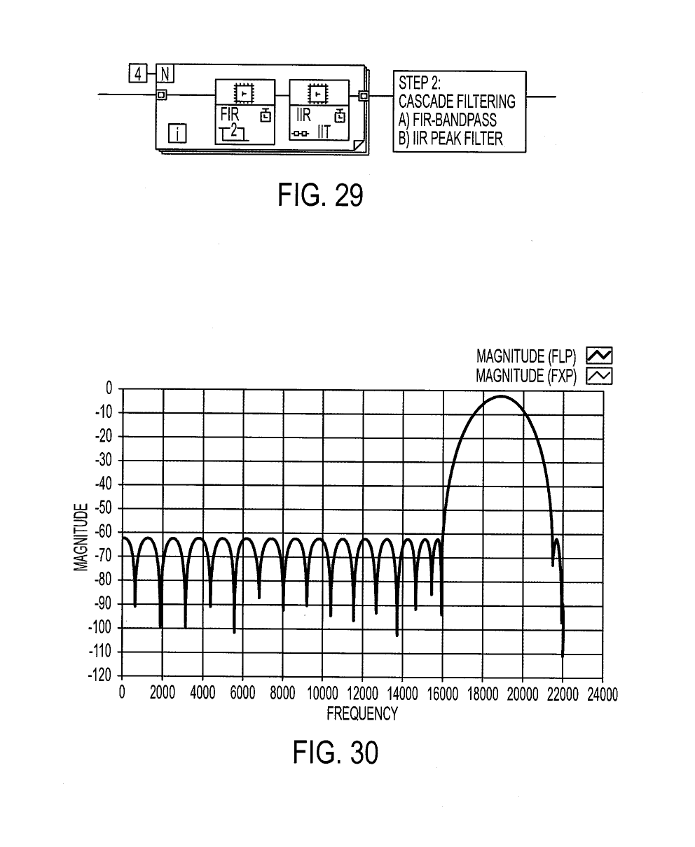

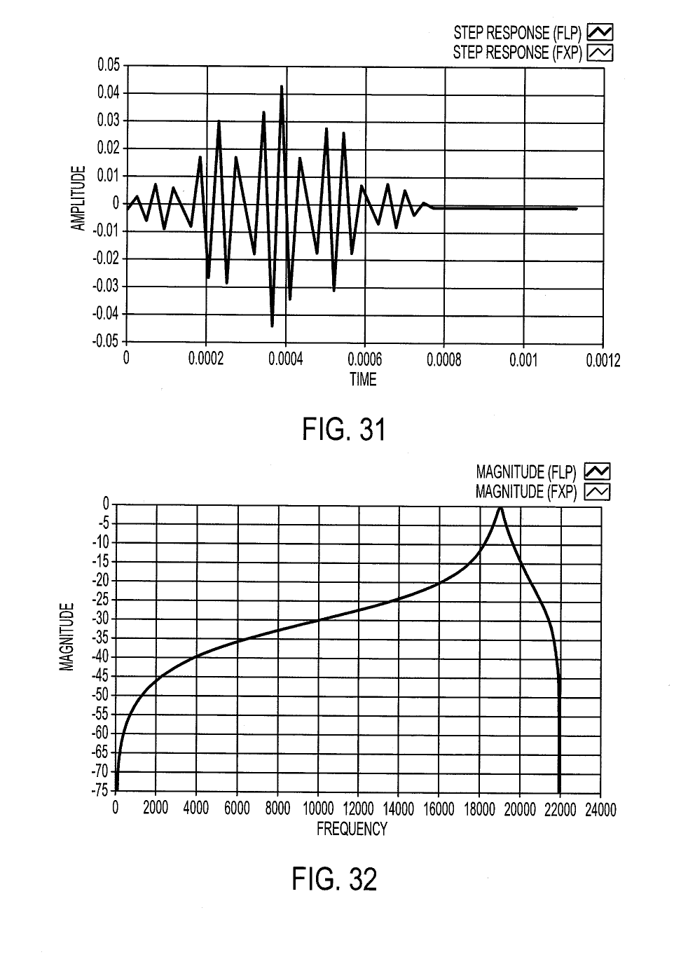

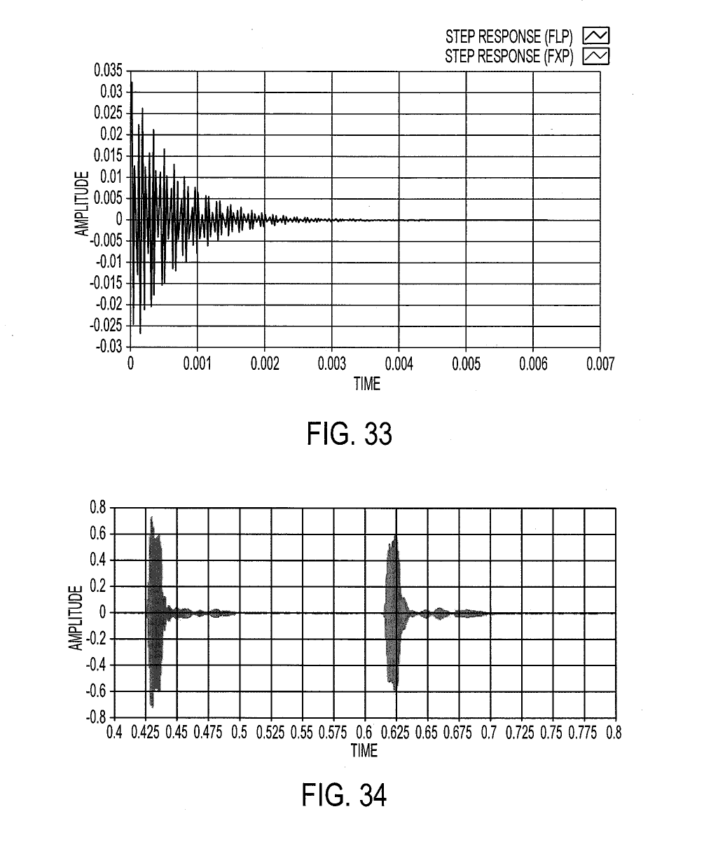

The sound filter was implemented in FPGA to keep the 19 KHz audio signal while reducing audio signals from other frequencies. FIGS. 27 and 28 illustrate the noise reduction behavior of a sound filter of the implementation. FIG. 29 illustrates the implementation of the sound filter in a Xilinx LX45 FPGA. The implementation included a cascade of FIR-band-pass filters and IIR peak filters for maximum noise reduction. FIGS. 30, 31, 32, and 33 show the filter implementation in LabView FPGA, a magnitude Bode Plot of the FIR Band pass filter, the step response of the FIR Band pass filter, and the step response of the IIR Filter, respectively.

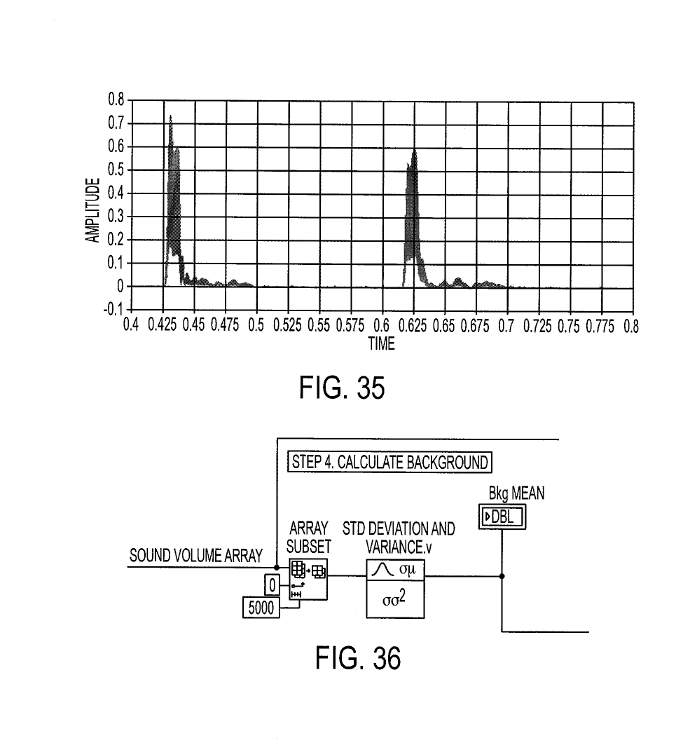

As mentioned, a microphone can configured to record the sound wave as oscillations around the 0-axis. The volume value, which is greater or equal to 0, was extracted from the sound recording for the purpose of efficient analysis. FIGS. 34 and 35 illustrate a volume extraction process used in the implementation. FIG. 34 is an input sound recording that contains two pulses. As shown in FIG. 34, the recording has positive and negative values due to the oscillatory nature of sound wave. FIG. 35 illustrates extracted volume data of the two pulses shown in FIG. 34.

The sound volume extraction was done in FPGA, and the following steps were implemented:

1) Performing an absolute value operation on microphone data;

2) Performing a 7-elements moving average operation on absolute values; and

3) Saving the result and passing it to a processor via a Direct Memory Access (DMA) channel.

Due to the existence of various interference, filtering artifacts, electronic noise and transducer distortions; background noise was quantified and removed from the volume data. To calculate background noise, the silent period in the recording was determined, and then an average of the volume during the silent period was calculated. FIG. 36 is a LabView Implementation illustrating the background noise calculation.

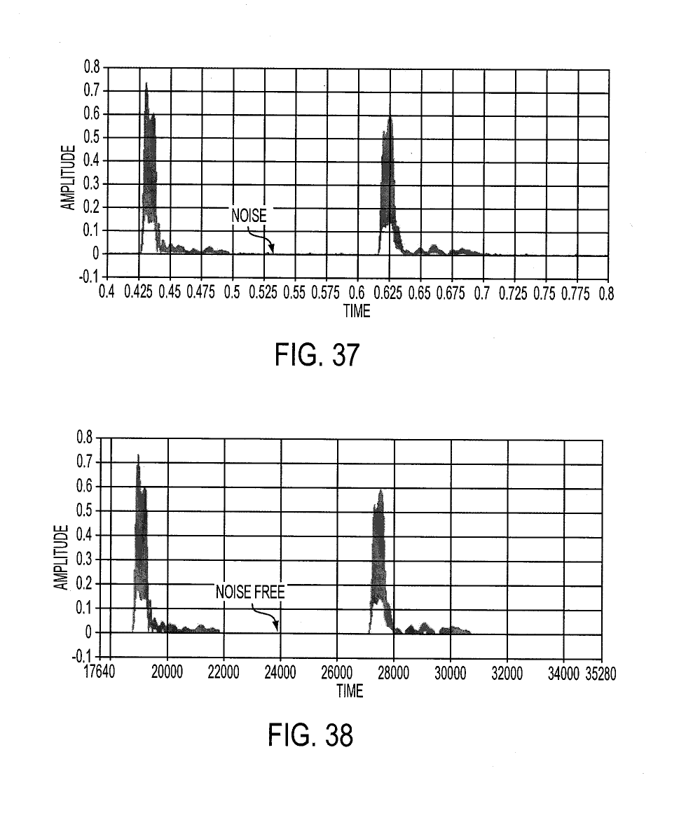

Background noise was calculated from the first 5000 elements in a sound volume array. The 5000 elements correspond to the initial silence, and it is currently a hard-coded value, and could be changed to a configurable parameter. The background noise that was calculated was then removed from the volume data, as illustrated in FIGS. 37 and 38. FIG. 37 is an illustration of the volume data prior to noise removal of the two pulses shown in FIG. 34 and

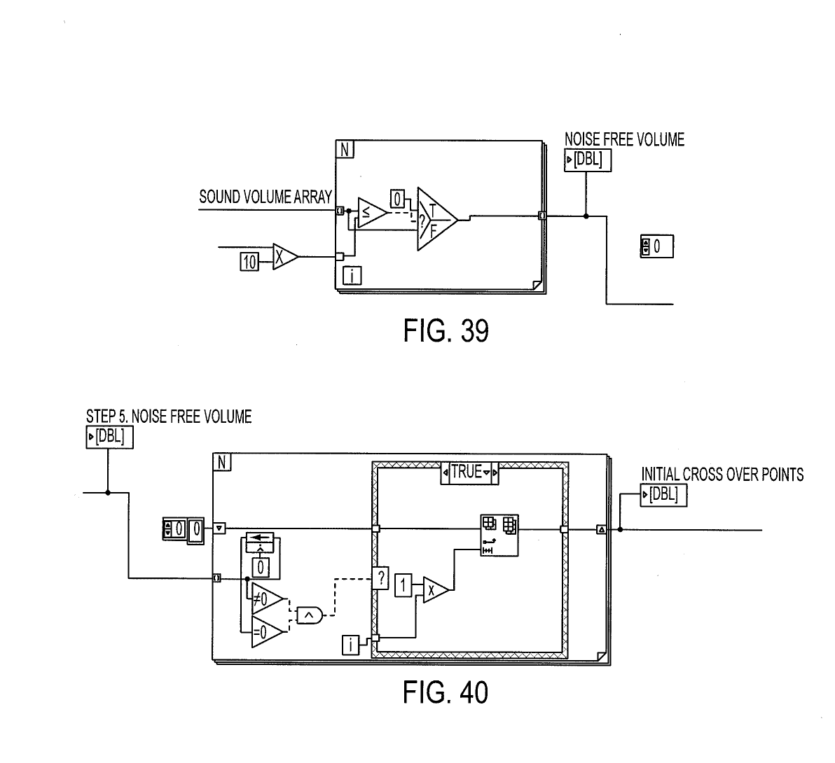

FIG. 39 is a LabView Implementation of noise removal and the following is a C++ Implementation:

| | |
|---|---|
| int NOISE_THRESHOLD=10; | // set noise filter threshold |
| double sound_volume[ ]; | // input, extracted sound volume |
| double bkg_mean; | // input, calculated average |
| | background from step 4. |
| double noise_free_volume[ ]; | // output, sound volume with |
| | noise removed |

double noise_gate=bkg_mean*NOISE_THRESHOLD;
for (int i=0; i< sizeof(sound_volume); i++){

if (sound_volume[i]<noise_gate){

noise_free_volume[i]=0;

else {

noise_free_volume[i]=sound_volume[i];

}

)

Pulses were defined as sounds with an energy level that is significantly higher than the background noise, and are thus potential candidates for pings. Pulse detection identified the starting time of sound pulses. The method for the pulse detection is fixed threshold technique with algorithm shown is FIG. 12. In addition, FIG. 40 is a LabView Implementation of the pulse detection algorithm.

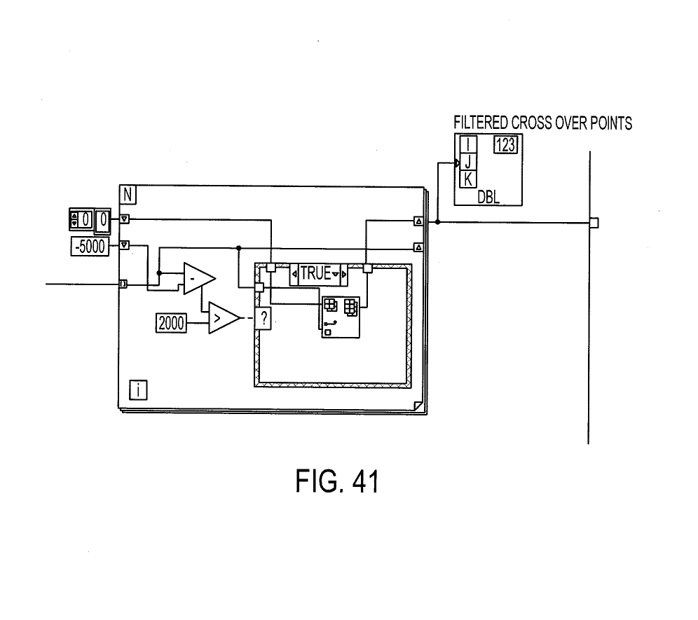

A list of time stamps of sound pulses was produced and the list was further filtered by eliminating sound pulses that are very close to earlier pulses using pulse down selection. Specifically, if the time difference between a pulse and the one preceding it was less than 4.5 ms or about 2000 samples, then that pulse was eliminated from the list because it is most likely a reverberation of an earlier pulse instead of a new pulse. FIG. 41 is a LabView Implementation of the pulse down selection used.

The previous step provided a list of time stamps of pulses that were potential candidates for the signature ultrasonic pings. To correctly identify a pulse from the list; the known fact that the silent interval between the two pings should be approximately 190 ms was used. An optimization-based search was performed on the list to pick a pair of time stamps, such that the time interval between them is closest to 190ms.

Table 1 illustrates the operation of the ping search that was used. The initial list of time stamps of pulses contains four values. After the search, 425.3288 ms and 614.5351 ms were identified as the start time of the 1st and 2nd pings respectively. The time difference between the two pings is 189.2066 ms, very close to the expected value of 190 ms.

TABLE 1

| Pulse Time Stamps (ms) | Ping? | Difference between pings (ms) |
|---|---|---|
| 2.108844 | No | 425.3288 − 614.5351 = |
| 128.8899 | No | 189.2066 |
| 425.3288 | 1^{st} Ping | |
| 614.5351 | 2nd Ping | |

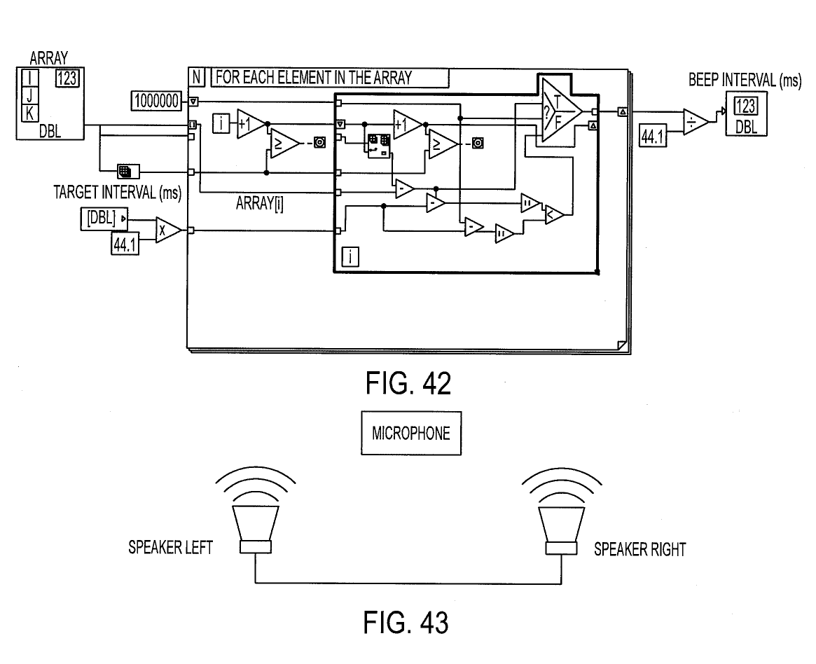

FIG. 42 is a LabView Implementation of a ping search algorithm and the following is example code used:

double difference_from_target=0;
// this calculate the difference between any two values in the array filtered_cross such that the difference
is closet to target_interval_sample
for (i=0;i<sizeof(filtered_crossover_points);i++){
for (j=0;j<sizeof(filtered_crossover_points);j++{

difference_from_target=abs((filetered_crossover_points[j]−filtered_crossover_points[i])*44.1−

target_interval);

if ( difference_from_target<found_interval){
found_interval= difference_from_target;
}

)
}

The relative placement of the microphone was calculated using the speed of sound by examining the slight time shift when the acoustic beep arrives at different microphone. The follow example explains how to determine the relative position based on two microphones placed at left and right side respectively.

First, pulses are detected according to:
T_{L1}, T_{L2}, T_{L3}, . . . , T_{Ln}=timestamps when pulses 1, 2, 3 . . . n are detected from left microphone
T_{R1},T_{R2}, T_{R3}, . . . , T_{Rn}=timestamps when pulses 1, 2, 3 . . . n are detected from the right microphone

Then, the average time differences between the detection timestamps are calculated. Additionally, the averaging process may help to reduce amount of noise in results.

$$Δ {T}_{avg} = \frac{1}{n} {\sum }_{i = 1}^{n} ( {T}_{Li} - {T}_{Ri} )$$

The relative distance is defined as the displacement from the center of the two microphones. If the speaker is d to the left of the center and speed of sound is v, the left speaker will detect the pulse d/v earlier while the right speaker will detect the pulse d/v, so the total time difference will be t=2d/v. Thus, difference d is given by d=0.5*t*v.

$$Relative Distance ( cm ) = 0.5 * 34.3 \frac{cm}{s} \cdot Δ {T}_{avg}$$

The sign of the relative distance indicates whether the beep source is to the left or right of the center. If the sign is positive, that means detection timestamp from left is larger than timestamp from the right. This indicates that it takes longer for the pulse to reach the left microphone, thus the phone is on the right side. If the sign is negative, by the same logic the phone is on the left side.

The above example illustrates one-dimensional distance calculation to distinguish between left and right. To achieve two-dimension localization (left/right, front/back) necessary to determine the driver zone in the front left of the vehicle, two sets of distances are calculated. The x-distance is the relative distance that indicates left or right from the middle of vehicle cabin, and is calculated from the relative time shift between the left and right microphones. The y-distance is the relative distance that indicates front or back of the driver, and is calculated from the relative time shift between front and back microphones. Based on x and y relative distances, location of left/right and front/back can be determined.

In the implementation shown above, the relative placement was −27 cm, or 27 cm to the right of the midpoint between two mircophones.

To remove fluctuation in the distance calculation due to noise and other unwanted mechanism, the distance value was filtered by performing a 4-element moving average filter. Based on experimental measurement, the following criteria to determine whether the mobile device is in the driver zone was implemented:

1) X distance <−15: the mobile device is to the left of the mid-point of the vehicle cabin by at least 15cm; and

2) Y distance <0: the mobile device is in the front half of the space.

In the event the mobile device was determined to be in the driver zone, the hardware was configured to send a “lock\n” message through a Bluetooth wireless connection.

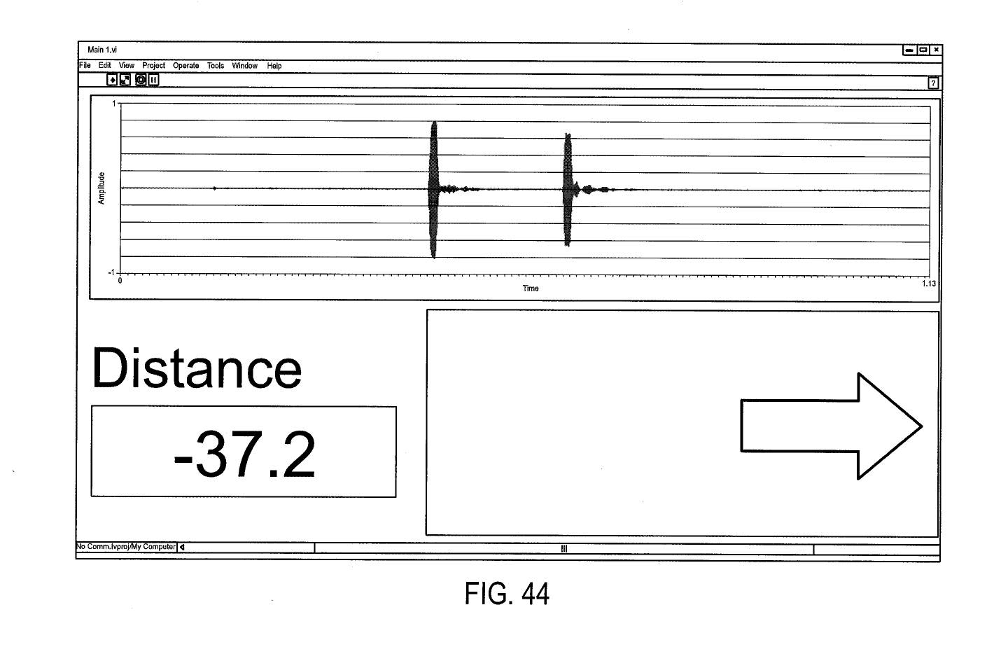

Furthermore, to demonstrate the feasibility of an ultrasonic location detection approach, demonstration software was built that used two speakers and a microphone to detect relative positions of left and right. The demonstration software succeeded in correctly identifying a relative position of left and right in two tests. A first test was conducted in a quiet room, while the second test was conducted in a vehicle cabin with engine turned on. FIG. 43 is an illustration of a setup of speakers and a microphone used during a test of demonstration software. In addition, FIG. 44 is a screenshot of the demonstration software, which correctly detected that the microphone is closer to the right speaker, and the relative distance is approximately 37cm to the right.

The first part of the demonstration software was a playback of ultrasonic pulses on stereo speakers. The set of ultrasonic pulses, or ping, contains the sound information outlined in Table 2.

TABLE 2

| Time | Left Channel | Left Channel | Comments |
|---|---|---|---|
| 0 ms | 0 | 0 | Silence |
| 0-10 ms | 19 KHz Sine | 0 | Left ultrasonic ping |
| | Wave | | |
| 10 ms-200 ms | 0 | 0 | 190 ms silence between |
| | | | pings |
| 200 ms-210 ms | 0 | 19 KHz Sine | Right ultrasonic ping |
| | | Wave | |
| 200 ms-300 ms | 0 | 0 | Silence |

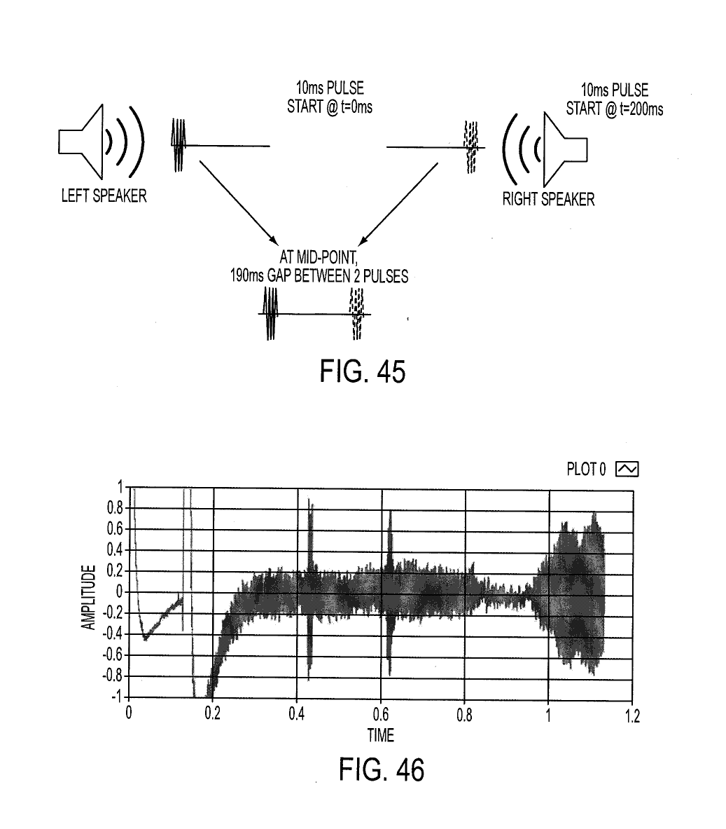

A graphical illustration of the ping playback is shown in FIG. 45.

For a microphone placed at the exact midpoint between the two speakers, the silent interval between the left and right pulses would be 190ms. If the location of the microphone deviates from the midpoint, the distance of deviation can be calculated from measured length of the silent interval between pulses:

$$Relative Distance ( cm ) = 34.3 \frac{cm}{s} \cdot ( length of silence between pulses - 190 ms )$$

The second part of the demonstration software was the receiver portion that records and analyzes an ultrasonic ping. The receiver portion of the software consisted of 10 processing steps summarized by Table 3:

TABLE 3

| # | Step | Details |
|---|---|---|
| 1 | Sound recorder | Record sound from the microphone. |
| 2 | Sound filter | Remove sound with frequency outside of 19 KHz range |
| 3 | Sound volume extraction | Convert oscillating sound waveform into volume envelope |
| 4 | Background noise | Estimate background noise |
| | extraction | |
| 5 | Background noise | Remove background noise from sound recording |
| | removal | |
| 6 | Initial pulses detection | Find all sound pulses that are significantly higher than the |
| | | noise |
| 7 | Pulses down selection | Eliminate sound pulses that are not likely to be of interest |
| 8 | Ping search | Search for a pair of pulses that have approximately 190 ms |
| | | separation |
| 9 | Distance calculation | Calculate the distance based on the pair of pings found in |
| | | stage 8. |
| 10 | Moving average | Remove statistical outlier |

The sound recording was synchronized with the start of the ping playback on the speakers.

The recording was done at sampling rate of 44 KHz with sound card signal processing turned off. According to Nyquist—Shannon sampling theorem, sound with frequency up to 22 KHz can be resolved with 44 KHz sampling frequency. Practically, the detection of sound was limited by the sensitivity of the microphones, which often have a high limit around 20 KHz.

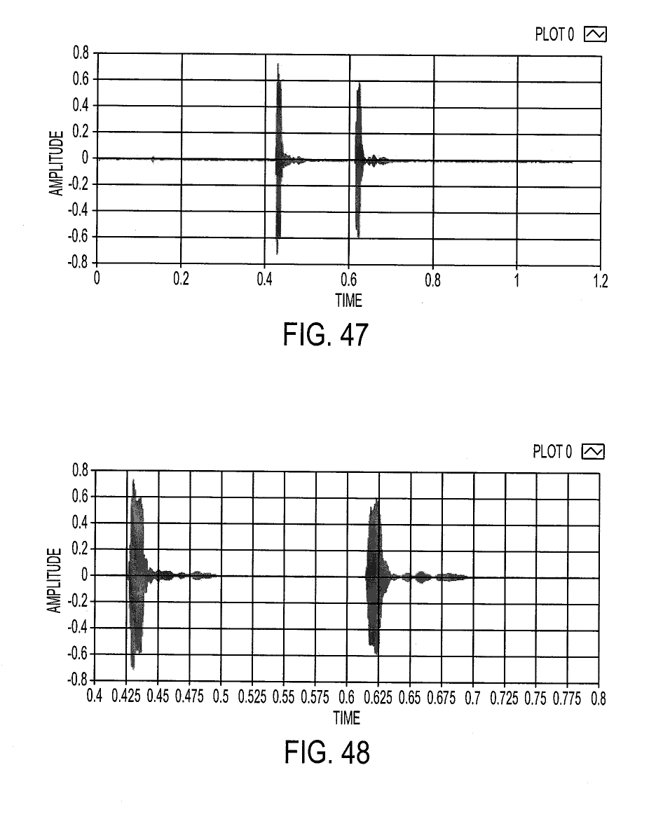

The sound recording was then filtered so that only the sound energy with frequency approximately 19 KHz is kept. FIGS. 46 and 47 illustrate the performance of the digital band pass filters. FIG. 46 is a time series plot of the raw sound recording. The pings were located at approximately 0.42 seconds and 0.62 seconds respectively. A loud music player was playing near the microphone to simulate loud acoustic environment in a vehicle cabin. The effect of the interference was clearly visible. FIG. 47 shows the time series plot of the same sound recording after the digital filter. Most of the interference was removed and the pings are clearly visible.

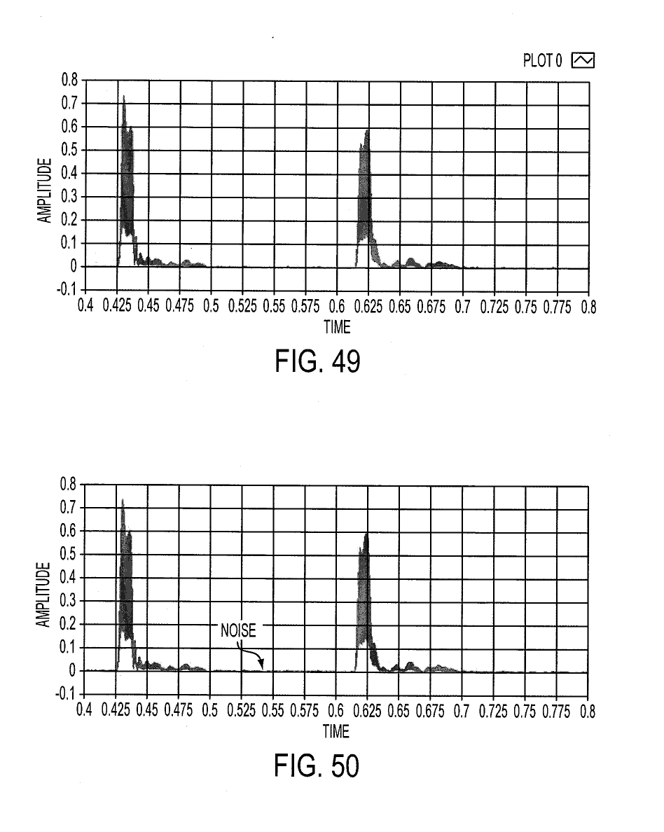

The microphone records the sound wave as oscillations around the 0-axis. The volume value, which is always greater or equal to 0, is extracted from the sound recording for the purpose of efficient analysis. FIGS. 48 and 49 illustrate the volume extraction process. FIG. 48 is the input sound recording that contains the two pings. The recording has positive and negative values due to the oscillatory nature of sound wave. FIG. 49 illustrates the extracted volume data of the two pings.

Due to the existence of interference, filtering artifacts, electronic noise and transducer distortions, the background noise was first quantified and then removed from the volume data. To calculate the background noise, the silent period in the recording was determined, and then the average of the volume during the silent period was calculated.

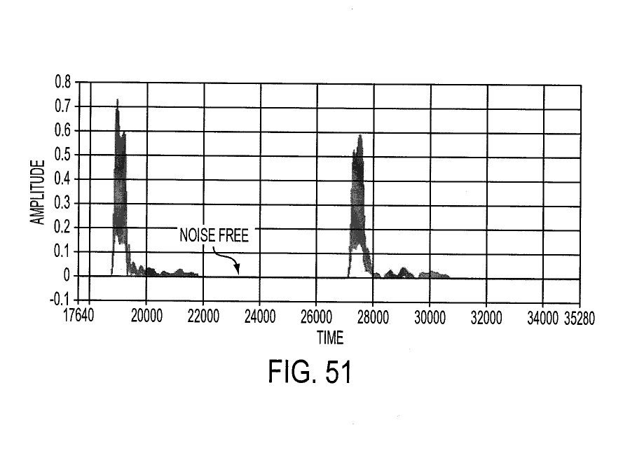

The background noise calculated in step 4 of Table 3 was then removed from the volume data, as illustrated by FIGS. 50 and 51. Pulses were defined as sounds with energy level that is significantly higher than the background noise, thus potential candidates for ping. This step identified the starting time of sound pulses. The method for the pulse detection was a fixed threshold technique with algorithm diagram shown in FIG. 12. Further, step 6 of Table 3 produced a list of time stamps of sound pulses. Step 7 of Table 3 further filtered the list by eliminating sound pulses that were very close to earlier pulses. Specifically, if the time difference between a pulse and a preceding pulse was less than 5ms, then the pulse was eliminated from the list because it is most likely a reverberation of an earlier ping instead of a new ping.

The step 7 provided a list of time stamps of pulses that were potential candidates for the signature ultrasonic pings. To correctly identify the ping from the list; the fact that the silent interval between the two pings should be approximately 190 ms was used. In step 8, an optimization-based search is performed on the list to pick a pair of time stamps, such that the time interval between them is closest to 190 ms.

Table 4 illustrates the operation of the ping search algorithm. The initial list of time stamps of pulses contains four values. After the search, 425.3288 ms and 614.5351 ms have been identified as the start time of the 1st and 2nd pings respectively. The time difference between the two pings is 189.2066 ms, very close to the expected value of 190 ms.

TABLE 4

| Pulse Time Stamps (ms) | Ping? | Difference between pings (ms) |
|---|---|---|
| 2.108844 | No | 425.3288 − 614.5351 = |
| 128.8899 | No | 189.2066 |
| 425.3288 | 1^{st} Ping | |
| 614.5351 | 2nd Ping | |

The relative placement of the microphone was calculated using the speed of sound.

$$Relative Distance ( cm ) = 34.3 \frac{cm}{s} \cdot ( length of silence between pings - 190 ms )$$

$$Relative Distance ( cm ) = 34.3 \frac{cm}{s} \cdot ( 189.2066 - 190 ) = - 27 cm$$

In this example, the relative placement was −27 cm, or 27 cm to the right of the midpoint between the two speakers. There are many sources of error that might lead to incorrect calculated distance from time to time. To eliminate the statistical outliers, the calculated distance was averaged over eight values. The moving average process significantly improves the accuracy at the expense of slower detection speed HO seconds).

The various illustrative functional elements, logical blocks, modules, circuits, and processors described in connection with the embodiments disclosed herein may be implemented or performed with an appropriate processor device, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein as appropriate. As described herein a processor may be a microprocessor, but in the alternative, the processor may be any conventional processor, controller, microcontroller, or state machine designed to perform the appropriate function. A processor may be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format.

The functions of the various functional elements, logical blocks, modules, and circuits elements described in connection with the embodiments disclosed herein may be performed through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the terms “processor” or “module” should not be construed to refer exclusively to hardware capable of executing software, and may implicitly include, without limitation, DSP hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The various functional elements, logical blocks, modules, and circuits elements described in connection with the embodiments disclosed herein may comprise a processing unit for executing software program instructions to provide computing and processing operations for the systems and methods described herein. A processing unit may be responsible for performing various voice and data communications operations between the mobile device and other components of an appropriate system. Although the processing unit may include a single processor architecture, it may be appreciated that any suitable processor architecture and/or any suitable number of processors in accordance with the described embodiments. In one embodiment, the processing unit may be implemented using a single integrated processor.

The functions of the various functional elements, logical blocks, modules, and circuits elements described in connection with the embodiments disclosed herein may also be implemented in the general context of computer executable instructions, such as software, control modules, logic, and/or logic modules executed by the processing unit. Generally, software, control modules, logic, and/or logic modules include any software element arranged to perform particular operations. Software, control modules, logic, and/or logic modules can include routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the example aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or example language (e.g., “such as”, “in the case”, “by way of example”) provided herein is intended merely to better illuminate the present disclosure and does not pose a limitation on the scope of the present disclosure otherwise claimed. No language in the specification should be construed as indicating any non-claimed element essential to the practice of the present disclosure. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

Various embodiments are described in the following numbered clauses:
1. A system for determining a presence of a mobile device located in a predetermined detection zone, the system comprising: a circuit associated with the mobile device, wherein the circuit is configured to cause an acoustic signal to be transmitted from the mobile device; a plurality of acoustic receivers, wherein each of the plurality of receivers is configured to receive the acoustic signal transmitted from the mobile device and convert the acoustic signal into an electrical signal; and a processor configured to determine a location of the mobile device based on the time of reception of the acoustic signal by the plurality of acoustic receivers and to determine whether the location of the mobile device matches the predetermined detection zone.
2. An apparatus for determining a presence of a mobile device located in a predetermined detection zone, the apparatus comprising: a circuit associated with a mobile device, wherein the circuit is coupled to a non-transitory memory that stores executable instructions, wherein the circuit is operable to execute the instructions to: cause an acoustic signal to be transmitted from the mobile device to a plurality of acoustic receivers; receive a command signal from a processor configured to determine a location of the mobile device based on the time of reception of the acoustic signal by the plurality of acoustic receivers and determine whether the location of the mobile device matches the predetermined detection zone; and inhibit at least one function of the mobile device upon reception of the command signal.
3. The apparatus of clause 2, wherein the circuit is located within the mobile device.
4. The apparatus of clause 3, wherein the circuit is configured to inhibit the at least one function of the mobile device upon the processor determining that the location of the mobile device matches the predetermined detection zone.
5. The apparatus of clause 3, wherein the circuit is configured to redirect at least one function of the mobile device to a hands-free alternate system upon the processor determining that the location of the mobile device matches the predetermined detection zone.
6. The apparatus of clause 2, wherein the acoustic signal comprises at least one ultrasonic pulse.
7. The apparatus of clause 6, wherein the at least one ultrasonic pulse is transmitted at a range of 15 kHz to 25kHz.
8. The apparatus of clause 7, wherein the at least one ultrasonic pulse is transmitted at a range of 18 kHz to 20kHz.
9. The apparatus of clause 8, wherein the at least one ultrasonic pulse is transmitted at 19 kHz.
10. An apparatus for determining a presence of a mobile device located in a predetermined detection zone, the apparatus comprising:

a processor coupled to a non-transitory memory that stores executable instructions, wherein the processor is operable to execute the instructions to:
receive a plurality of electrical signals from a plurality of acoustic receivers, wherein each electrical signal is based on an acoustic signal received by each of the plurality of acoustic receivers;
determine a location of a mobile device based on the time of reception of the acoustic signal by the plurality of acoustic receivers;
determine whether the location of the mobile device matches the predetermined detection zone.
11. The apparatus of clause 10, further comprising the plurality of acoustic receivers, wherein each of the plurality of receivers is configured to receive the acoustic signal transmitted from the mobile device and convert the acoustic signal into the electrical signal.
12. The apparatus of clause 11, wherein the plurality of acoustic receivers comprises at least three microphone devices.
13. The apparatus of clause 10, wherein the acoustic signal comprises at least one ultrasonic pulse.
14. The apparatus of clause 13, wherein the at least one ultrasonic pulse is transmitted at a range of 15 kHz to 25kHz.
15. The apparatus of clause 14, wherein the at least one ultrasonic pulse is transmitted at a range of 18 kHz to 20kHz.
16. The apparatus of clause 15, wherein the at least one ultrasonic pulse is transmitted at 19 kHz.
17. The apparatus of clause 10, wherein the processor is operable to determine the location of the mobile device based on a distance from the mobile device to each of the plurality of acoustic receivers.
18. The apparatus of clause 17, wherein the processor is operable to determine the distance of the mobile device to each of the plurality of acoustic receivers based on a time difference in reception at each of the plurality of acoustic receivers of the acoustic signal, wherein the acoustic signal is transmitted from the mobile device.
19. The apparatus of clause 10, wherein the processor is configured to determine the location of the mobile device based on triangulation.
20. The apparatus of clause 10, wherein the processor is operable to receive a Bluetooth signal transmitted by the mobile device.
21 A method for determining a presence of a mobile device located in a predetermined detection zone, the method comprising: transmitting, by the mobile device, an acoustic signal; receiving, at each of a plurality of acoustic receivers, the acoustic signal transmitted from the mobile device; determining, by a processor, a location of the mobile device based on the received acoustic signal; determining whether the location of the mobile device matches the predetermined detection zone; and inhibiting at least one function of the mobile device upon determining that the location of the mobile device matches the predetermined detection zone.
22. A system for determining a presence of a mobile device located in a predetermined detection zone within a vehicle, the system comprising: a plurality of transmitters located within the vehicle, wherein each of the plurality of transmitters is configured to transmit an acoustic signal; a mobile device configured to receive each acoustic signal transmitted by the plurality of transmitters; and a processor configured to determine a location of the mobile device within the vehicle based on the acoustic signals transmitted by the plurality of transmitters and received by the mobile device, to determine whether the location of the mobile device matches the predetermined detection zone, and to cause the mobile device to inhibit at least one function of the mobile device upon determining that the location of the mobile device matches the predetermined detection zone; and wherein each of the acoustic signals comprises at least one ultrasonic pulse at 19 kHz.
23. The system of clause 22, wherein the processor is a mobile application processor.
24. A method for determining a presence of a mobile device located in a predetermined detection zone within a vehicle, the method comprising: transmitting, by each of a plurality of transmitters located within the vehicle, acoustic signals to the mobile device; receiving, by the mobile device, each acoustic signal transmitted by the plurality of transmitters; determining, by a processor, a location of the mobile device within the vehicle based on the communication signals transmitted by the plurality of transmitters and received by the mobile device; determining whether the location of the mobile device matches the predetermined detection zone; and inhibiting at least one function of the mobile device upon determining that the location of the mobile device matches the predetermined detection zone; and wherein each of the acoustic signals comprises at least one ultrasonic pulse at 19 kHz.
25. The method of clause 24, wherein the plurality of transmitters are a plurality of speaker devices.
26. The method of clause 24, wherein each acoustic signal comprises at least one ultrasonic pulse.
27. The method of clause 26, wherein the at least one ultrasonic pulse is transmitted at 19 kHz.
28. The method of clause 24, wherein determining the location of the mobile device comprises determining the location of the mobile device based on a distance from the mobile device to each of the plurality of receivers.
29. The method of clause 28, wherein the distance of the mobile device to each of the plurality of receivers is determined based on time difference in reception at each of the plurality of receivers of the acoustic signal transmitted from the mobile device.
30. The system of clause 29, wherein determining the location of the mobile device comprises determining the location of the mobile device based on triangulation.

1. A system for determining a presence of a mobile device located in a predetermined detection zone, the system comprising:
a circuit associated with the mobile device, wherein the circuit is configured to cause an acoustic signal to be transmitted from the mobile device;
a plurality of acoustic receivers, wherein each of the plurality of receivers is configured to receive the acoustic signal transmitted from the mobile device and convert the acoustic signal into an electrical signal; and
a processor configured to determine a location of the mobile device based on the time of reception of the acoustic signal by the plurality of acoustic receivers and to determine whether the location of the mobile device matches the predetermined detection zone.

2. An apparatus for determining a presence of a mobile device located in a predetermined detection zone, the apparatus comprising:
a circuit associated with a mobile device, wherein the circuit is coupled to a nontransitory memory that stores executable instructions, wherein the circuit is operable to execute the instructions to:
cause an acoustic signal to be transmitted from the mobile device to a plurality of acoustic receivers;
receive a command signal from a processor configured to determine a location of the mobile device based on the time of reception of the acoustic signal by the plurality of acoustic receivers and determine whether the location of the mobile device matches the predetermined detection zone; and
inhibit at least one function of the mobile device upon reception of the command signal.

3. The apparatus of claim 2, wherein the circuit is located within the mobile device.

4. The apparatus of claim 3, wherein the circuit is configured to inhibit the at least one function of the mobile device upon the processor determining that the location of the mobile device matches the predetermined detection zone.

5. The apparatus of claim 3, wherein the circuit is configured to redirect at least one function of the mobile device to a hands-free alternate system upon the processor determining that the location of the mobile device matches the predetermined detection zone.

6. The apparatus of claim 2, wherein the acoustic signal comprises at least one ultrasonic pulse.

7. The apparatus of claim 6, wherein the at least one ultrasonic pulse is transmitted at a range of 15 kHz to 25 kHz.

8. The apparatus of claim 7, wherein the at least one ultrasonic pulse is transmitted at a range of 18 kHz to 20 kHz.

9. The apparatus of claim 8, wherein the at least one ultrasonic pulse is transmitted at 19 kHz.

10. An apparatus for determining a presence of a mobile device located in a predetermined detection zone, the apparatus comprising:
a processor coupled to a non-transitory memory that stores executable instructions, wherein the processor is operable to execute the instructions to:
receive a plurality of electrical signals from a plurality of acoustic receivers, wherein each electrical signal is based on an acoustic signal received by each of the plurality of acoustic receivers;
determine a location of a mobile device based on the time of reception of the acoustic signal by the plurality of acoustic receivers;
determine whether the location of the mobile device matches the predetermined detection zone.

11. The apparatus of claim 10, further comprising the plurality of acoustic receivers, wherein each of the plurality of receivers is configured to receive the acoustic signal transmitted from the mobile device and convert the acoustic signal into the electrical signal.

12. The apparatus of claim 11, wherein the plurality of acoustic receivers comprises at least three microphone devices.

13. The apparatus of claim 10, wherein the acoustic signal comprises at least one ultrasonic pulse.

14. The apparatus of claim 13, wherein the at least one ultrasonic pulse is transmitted at a range of 15 kHz to 25 kHz.

15. The apparatus of claim 14, wherein the at least one ultrasonic pulse is transmitted at a range of 18 kHz to 20 kHz.

16. The apparatus of claim 15, wherein the at least one ultrasonic pulse is transmitted at 19 kHz.

17. The apparatus of claim 10, wherein the processor is operable to determine the location of the mobile device based on a distance from the mobile device to each of the plurality of acoustic receivers.

18. The apparatus of claim 17, wherein the processor is operable to determine the distance of the mobile device to each of the plurality of acoustic receivers based on a time difference in reception at each of the plurality of acoustic receivers of the acoustic signal, wherein the acoustic signal is transmitted from the mobile device.

19. The apparatus of claim 10, wherein the processor is configured to determine the location of the mobile device based on triangulation.

20. The apparatus of claim 10, wherein the processor is operable to receive a Bluetooth signal transmitted by the mobile device.

21-30. (canceled)
